(19) United States
(12) Patent Application Publication
(10) Pub. No.: US 2015/0100416 A1
(43) Pub. Date: Apr. 9, 2015

(54) STRATEGIC MARKETING BASED ON ELECTRONIC COMMUNICATION ANALYSIS

(71) Applicant: BANK OF AMERICA CORPORATION, Charlotte, NC (US)

(72) Inventors: Jason P. Blackhurst, Charlotte, NC (US); Laura C. Bondesen, Charlotte, NC (US); Matthew A. Calman, Charlotte, NC (US); Katherine Dintenfass, Charlotte, NC (US); Carrie Anne Hanson, Charlotte, NC (US)

(73) Assignee: BANK OF AMERICA CORPORATION, Charlotte, NC (US)

(21) Appl. No.: 14/049,808

(22) Filed: Oct. 9, 2013

(51) Int. Cl. G06Q 30/02

(52) U.S. Cl. CPC G06Q 30/0253
USPC 705/14.51

(57) ABSTRACT

Embodiments of the invention are directed to systems, methods and computer program products for providing electronic communications based on interactive marketing analysis. An exemplary apparatus is configured to receive purchase transaction data associated with identified electronic communications between a merchant and a customer regarding a transaction, wherein the purchase transaction data includes product level data from a transaction, receive interactive marketing data associated with identified electronic communications between a merchant and a customer regarding an offer or advertisement, determine the customer's personal interests based at least partially on an analysis of the purchase transaction data and interactive marketing data, and provide the customer an electronic communication based at least partially on determining the customer will be interested in at least one offer or advertisement, wherein the electronic communication includes the at least one offer or advertisement.

### BACKGROUND

In the past few years, there has been an increase in the amount of electronic information provided by merchants to customers and/or potential customers regarding the purchase of products and services.

Merchants use electronic communication as a means to provide customers with information related to their recent purchases. When a purchase is made online, various electronic communications may be provided to the customer from the merchant relative to a purchase, such as an order confirmation. The communications may be sent to the customer's computer and displayed in a web browser application. The web browser application typically allows the customer to print a hard copy of the order confirmation and to save the confirmation electronically. The merchant will also typically send an email containing the order confirmation to the customer's designated email account. The order confirmation is essentially an e-receipt for the online purchase.

Many merchants are also providing customers the option of receiving e-receipts when the customer is shopping at a brick and mortar merchant location. As such, e-receipts are becoming a popular means of receiving order confirmations when shopping online or at a brick and mortar location.

Another development in the past few years has been the growth of online banking, whereby financial institution customers, (such as bank and credit card customers), may view financial account transaction data.

Merchants also use electronic communication as a means of marketing by providing customers with offers and various opportunities to deepen the customer relationship with companies of interest. Customers receive offers directly via their email accounts, and indirectly through third party marketing websites or while visiting the merchant's personal website. This effort of mass marketing often is not personalized for each individual customer which results in a mass marketing attempt that eventually discourages customer participation due to lack of interest in the various offers provided. Customers receive emails that contain several offers and advertisements, none of which are of any personal interest to the potential customer. This tactic executed in a repetitive nature eventually leads to the customer anticipating a lack of interest and failing to acknowledge the marketing communication altogether.

A need exist for a system that can determine which marketing efforts a customer is interested in by analyzing their financial data as well as their interaction with marketing strategies previously provided via electronic communication.

### BRIEF SUMMARY

Embodiments of the invention are directed to systems, methods, and computer program products providing electronic communications based on interactive marketing analysis. An exemplary apparatus for providing electronic communications based on interactive marketing analysis may comprise a memory, a processor, and a module stored in the memory, executable by the processor, and configured to receive purchase transaction data associated with identified electronic communications between a merchant and a customer regarding a transaction, wherein the purchase transaction data includes product level data from a transaction, receive interactive marketing data associated with identified electronic communications between a merchant and a customer regarding an offer or advertisement, determine the customer's personal interests based at least partially on an analysis of the purchase transaction data and interactive marketing data, and provide the customer an electronic communication based at least partially on determining the customer will be interested in at least one offer or advertisement, wherein the electronic communication includes the at least one offer or advertisement.

In some embodiments, determining the customer's personal interest comprises the module being further configured to categorize, into hierarchical tiers, the level of interaction the customer had with the identified electronic communications.

In some embodiments, the identified electronic communication is an email, and analyzing the interactive marketing data comprises the module being further configured to determine the customer received the email, determine whether or not the customer opened the email, and determine whether or not the customer exhibited interest in the content of the email.

In some embodiments, the module is further configured to determine the customer exhibited interest in the content of the email in response to the customer requesting additional information for the offer or advertisement provided within the electronic communication.

In some embodiments, analyzing the interactive marketing data comprises the module being further configured to determine the customer accepted an offer presented in the identified electronic communication in response to the merchant receiving a payment from the customer for a product or service provided in the offer.

In some embodiments, analyzing the interactive marketing data comprises the module being further configured to determine the customer was interested in an advertisement presented in the identified electronic communication in response to determining the customer purchased a product or service from a merchant on a day specified in the advertisement.

In some embodiments, analyzing the interactive marketing data comprises the module being further configured to determine the customer was interested in an offer presented in the identified electronic communication in response to the customer downloading a coupon or using a promotional code provided in the electronic communication.

In some embodiments, providing the customer an electronic communication comprises the module being further configured to determine, based on the customer's personal interest, a subject line for the electronic communication such that the subject line will increase the probability of the customer acknowledging the electronic communication, and determine, based on the customer's personal interest, the content of the electronic communication such that the customer will be interested in at least one offer or advertisement provided in the electronic communication.

In some embodiments, providing the customer an electronic communication comprises the module being further configured to determine to resend the customer an electronic communication that was previously sent, and update a portion of the content within the electronic communication, if any offers have expired, prior to resending the electronic communication.

In some embodiments, the purchase transaction data is received in an unstructured format, and the module is further configured to convert the purchase transaction data from the unstructured format to a structured format, and associate the structured purchase transaction data with the customer's online banking application.

In some embodiments, the interactive marketing data is received in an unstructured format, and the module is further configured to convert the interactive marketing data from the unstructured format to a structured format, and associate the structured interactive marketing data with the customer's online banking application.

An exemplary method may comprise one or more steps for providing electronic communications based on interactive marketing analysis, including, receiving, using a computer processing device, purchase transaction data associated with identified electronic communications between a merchant and a customer regarding a transaction, wherein the purchase transaction data includes product level data from a transaction, receiving, using a computer processing device, interactive marketing data associated with identified electronic communications between a merchant and a customer regarding an offer or advertisement, determining, using a computer processing device, the customer's personal interests based at least partially on an analysis of the purchase transaction data and interactive marketing data, and providing, using a computer processing device, the customer an electronic communication based at least partially on determining the customer will be interested in at least one offer or advertisement, wherein the electronic communication includes the at least one offer or advertisement.

In some embodiments, determining the customer's personal interest comprises categorizing, into hierarchical tiers, the level of interaction the customer had with the identified electronic communications.

In some embodiments, the identified electronic communication is an email, and analyzing the interactive marketing data comprises determining the customer received the email, determining whether or not the customer opened the email, and determining whether or not the customer exhibited interest in the content of the email.

In some embodiments, providing the customer an electronic communication comprises determining, based on the customer's personal interest, a subject line for the electronic communication such that the subject line will increase the probability of the customer acknowledging the electronic communication, and determining, based on the customer's personal interest, the content of the electronic communication such that the customer will be interested in at least one offer or advertisement provided in the electronic communication.

In some embodiments, providing the customer an electronic communication comprises determining to resend the customer an electronic communication that was previously sent, and updating a portion of the content within the electronic communication, if any offers have expired, prior to resending the electronic communication.

In some embodiments, the purchase transaction data and interactive marketing data are received in an unstructured format, and wherein the method further comprises converting the purchase transaction data from the unstructured format to a structured format, associating the structured purchase transaction data with the customer's online banking application, converting the interactive marketing data from the unstructured format to a structured format, and associating the structured interactive marketing data with the customer's online banking application.

A computer program product may be provided for providing electronic communications based on interactive marketing analysis, the computer program product comprising a non-transitory computer-readable medium comprising a set of codes for causing a computer to receive purchase transaction data associated with identified electronic communications between a merchant and a customer regarding a transaction, wherein the purchase transaction data includes product level data from a transaction, receive interactive marketing data associated with identified electronic communications between a merchant and a customer regarding an offer or advertisement, determine the customer's personal interests based at least partially on an analysis of the purchase transaction data and interactive marketing data; and provide the customer an electronic communication based at least partially on determining the customer will be interested in at least one offer or advertisement, wherein the electronic communication includes the at least one offer or advertisement.

In some embodiments, the computer program product further comprising a set of codes for causing a computer to categorize, into hierarchical tiers, the level of interaction the customer had with the identified electronic communications.

In some embodiments, the identified electronic communication is an email, and the computer program product further comprising a set of codes for causing a computer to determine the customer received the email, determine whether or not the customer opened the email, and determine whether or not the customer exhibited interest in the content of the email.

In some embodiments, the computer program product further comprising a set of codes for causing a computer to determine, based on the customer's personal interest, a subject line for the electronic communication such that the subject line will increase the probability of the customer acknowledging the electronic communication, and determine, based on the customer's personal interest, the content of the electronic communication such that the customer will be interested in at least one offer or advertisement provided in the electronic communication.

In some embodiments, the computer program product further comprising a set of codes for causing a computer to determine to resend the customer an electronic communication that was previously sent, and update a portion of the content within the electronic communication, if any offers have expired, prior to resending the electronic communication.

In some embodiments, the purchase transaction data and interactive marketing data are received in an unstructured format, and wherein the computer program product further comprising a set of codes for causing a computer to convert the purchase transaction data from the unstructured format to a structured format, associate the structured purchase transaction data with the customer's online banking application, convert the interactive marketing data from the unstructured format to a structured format, and associate the structured interactive marketing data with the customer's online banking application

### BRIEF DESCRIPTION OF THE DRAWINGS

Having thus described embodiments of the invention in general terms, reference will now be made to the accompanying drawings, where:

FIG. 1A is a flowchart illustrating a general process flow illustrating the integration of purchase transaction level data from e-receipts into an online banking application process, in accordance with embodiments of the present invention;

FIG. 1B is a flowchart illustrating a general process flow for integrating interactive marketing data from electronic communications into an online banking application process, in accordance with embodiments of the present invention;

FIG. 1C is a flowchart illustrating a general process flow for providing strategic marketing based on interactive marketing analysis, in accordance with embodiments of the present invention;

FIG. 2 is a diagram illustrating a system environment for providing price evaluation based on electronic receipt data, in accordance with embodiments of the present invention;

FIG. 3A an illustration of an interface of an electronic communication between a merchant and a customer providing purchase transaction data to the customer, in accordance with embodiments of the present invention;

FIG. 3B an illustration of an interface of an electronic communication between a merchant and a customer providing marketing data to the customer, in accordance with embodiments of the present invention;

FIG. 4A provides a process map illustrating various electronic communications between a customer and merchant;

FIG. 4B provides a process map illustrating various electronic communications between a customer and merchant;

FIG. 5A is a flowchart illustrating converting the electronic communication to usable purchase transaction level data, in accordance with embodiments of the present invention;

FIG. 5B is a flowchart illustrating converting the electronic communication to usable marketing data, in accordance with embodiments of the present invention;

FIG. 6 is a flowchart illustrating the integration of purchase transaction level data from e-receipts into an online banking application, in accordance with embodiments of the present invention;

FIG. 7 is a decision map illustrating the customer's implementation of integration of purchase transaction level data from e-receipts into an online banking application process, in accordance with embodiments of the present invention;

FIG. 8 is an illustration of an interface of an online banking application with the electronic communications associated therewith, in accordance with embodiments of the present invention; and

FIG. 9 is a diagram illustrating hierarchal tiers for customer interaction levels, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout.

Embodiments of the invention are directed to systems, methods and computer program products that provide for strategic marketing based on interactive marketing analysis. The invention analyzes a customer's electronic receipt data in addition to the customer's interaction with marketing messages that have been electronically communicated to the customer to determine the customer's interest and strategically market future promotions.

As used herein, the term “a” and/or “an” shall mean “one or more,” even though the phrase “one or more” is also used herein. Where possible, any terms expressed in the singular form herein are meant to also include the plural form and vice versa, unless explicitly stated otherwise.

Furthermore, the term “electronic receipt” or “e-receipt” as used herein may include any electronic communication between a merchant and a customer, where the communication is associated with a transaction. In this way, e-receipts may include information about the transaction, such as location of purchase, the transaction total, order confirmations, shipping confirmations, item description, SKU data, merchant name, merchant web address, order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like.

The term “purchase transaction data” as used herein may include any data about the transaction identified in a communication between a merchant and a customer. This data may include the same or similar data as to what is on an e-receipt.

The term “electronic marketing” or “e-marketing” as used herein may include any electronic communication between a merchant and a customer or potential customer, where the communication is associated with an offer or an advertisement. Electronic marketing refers to the application of marketing principles and techniques via electronic media and more specifically the Internet. The terms e-marketing, internet marketing and online marketing may be used interchangeably throughout the specification. E-marketing is the process of marketing a brand, such as a merchant, using the Internet. It includes both direct response marketing and indirect marketing elements and uses a range of technologies to help connect businesses to their customers and/or potential customers. By such a definition, e-marketing encompasses all the activities a business conducts via the worldwide web with the aim of attracting new business, retaining current business and developing its brand identity.

The term “offer” may include merchant sales, coupons, discounts, rewards points/loyalty discounts, and/or the like. In this way, offers may include information detailing the terms of the one or more offers, such the location of the offer (e.g. online, in-store, or the like), merchant name, merchant telephone number, merchant address, merchant hours/days of operation, merchant web address, offer expiration date, product description, product name, product price, product image, hyperlink to the product image on the merchant website or a third party website, offer image, hyperlink to the offer image on the merchant website or a third party website, and the like. The term “advertisement” as used herein may include any notice or announcement in a public medium promoting a product, service, or event or publicizing an opportunity.

The term “interactive marketing data” as used herein may include any data about the electronic marketing identified in a communication between a merchant and a customer. This data may include information about whether the customer, acknowledged, further inquired about, accepted, and or declined an offer.

In some embodiments, an “entity” may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that offer payment account systems to customers.

Some portions of this disclosure are written in terms of a financial institution's unique position with respect to customer transactions, offers, or advertisements. As such, a financial institution may be able to utilize its unique position to create and update online banking applications associated with customers of the financial institution.

In some embodiments, the “user” may be a customer (e.g., an account holder or a person who has an account (e.g., banking account, credit account, or the like) at the entity) or potential customer (e.g., a person who has submitted an application for an account, a person who is the target of marketing materials that are distributed by the entity, a person who applies for a loan that not yet been funded). The terms user, customer and/or consumer may be used interchangeably throughout the specification.

The embodiments described herein may refer to the use of a transaction, transaction event or point of transaction event to trigger the steps, functions, routines, or the like described herein. In various embodiments, occurrence of a transaction triggers the sending of information such as offers and the like. Unless specifically limited by the context, a “transaction”, “transaction event” or “point of transaction event” refers to any communication between the customer and the merchant, e.g. financial institution, or other entity monitoring the customer's activities. In some embodiments, for example, a transaction may refer to a purchase of goods or services, a return of goods or services, a payment transaction, a credit transaction, or other interaction involving a customer's bank account.

In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by the entity. In other embodiments, an entity may not be a financial institution. In still other embodiments, the entity may be the merchant itself. As used herein, a “bank account” refers to a credit account, a debit/deposit account, or the like.

Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a customer's computer or mobile device, a customer accessing their e-wallet or any other interaction involving the customer and/or the customer's device that is detectable by the financial institution. As further examples, a transaction may occur when an entity associated with the customer is alerted via the transaction of the customer's location. A transaction may occur when a customer accesses a building, uses a rewards card, and/or performs an account balance query. A transaction may occur as a customer's mobile device establishes a wireless connection, such as a Wi-Fi connection, with a point-of-sale (or point-of-transaction) terminal. In some embodiments, a transaction may include one or more of the following: purchasing, renting, selling, and/or leasing goods and/or services (e.g., groceries, stamps, tickets, DVDs, vending machine items, and the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a customer's device, such as a customer's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the customer's perspective, the merchant's perspective or both. In some embodiments, the point-of-transaction device refers only to a customer's device, in other embodiments it refers only to a merchant device, and in yet other embodiments, it refers to both a customer device and a merchant device interacting to perform a transaction. For example, in one embodiment, the point-of-transaction device refers to the customer's mobile device configured to communicate with a merchant's point of sale terminal, whereas in other embodiments, the point-of-transaction device refers to the merchant's point of sale terminal configured to communicate with a customer's mobile device, and in yet other embodiments, the point-of-transaction device refers to both the customer's mobile device and the merchant's point of sale terminal configured to communicate with each other to carry out a transaction.

In some embodiments, a point-of-transaction device is or includes an interactive computer terminal that is configured to initiate, perform, complete, and/or facilitate one or more transactions. A point-of-transaction device could be or include any device that a customer may use to perform a transaction with an entity, such as, but not limited to, an ATM, a loyalty device such as a rewards card, loyalty card or other loyalty device, a magnetic-based payment device (e.g., a credit card, debit card, or the like), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, a point-of-transaction device is operated in a public place (e.g., on a street corner, at the doorstep of a private residence, in an open market, at a public rest stop, or the like). In other embodiments, the point-of-transaction device is additionally or alternatively operated in a place of business (e.g., in a retail store, post office, banking center, grocery store, factory floor, or the like). In accordance with some embodiments, the point-of-transaction device is not owned by the customer of the point-of-transaction device. Rather, in some embodiments, the point-of-transaction device is owned by a mobile business operator or a point-of-transaction operator (e.g., merchant, vendor, salesperson, or the like). In yet other embodiments, the point-of-transaction device is owned by the financial institution offering the point-of-transaction device providing functionality in accordance with embodiments of the invention described herein.

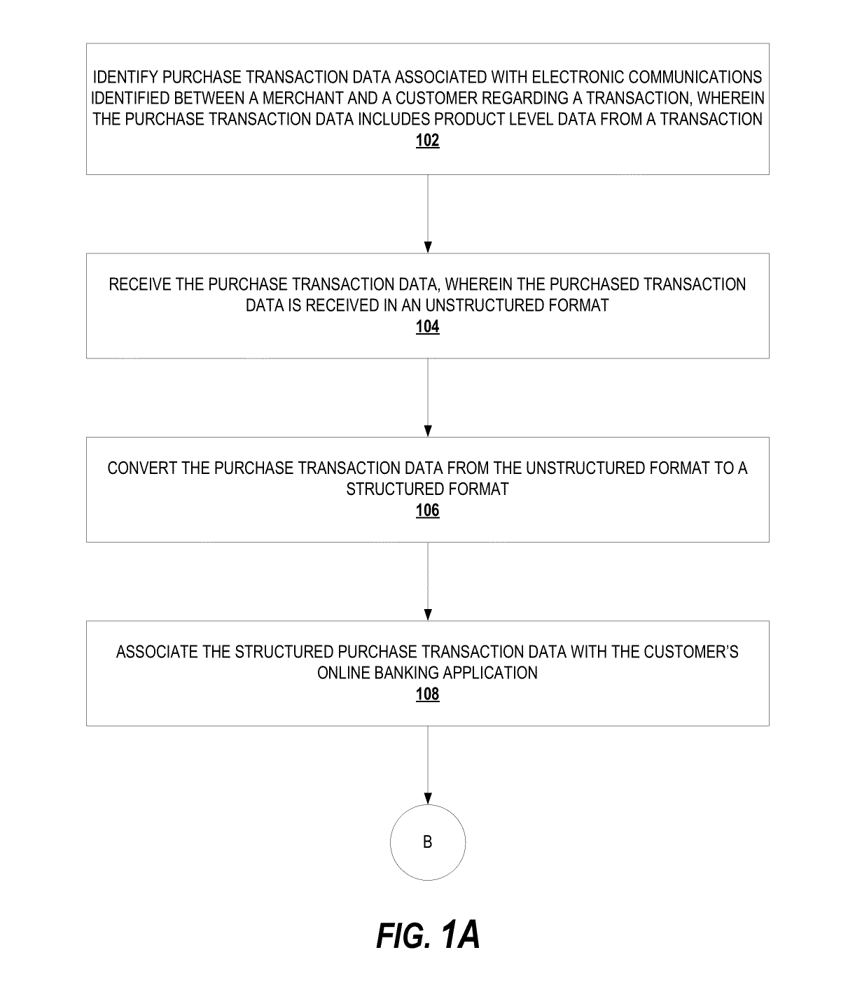

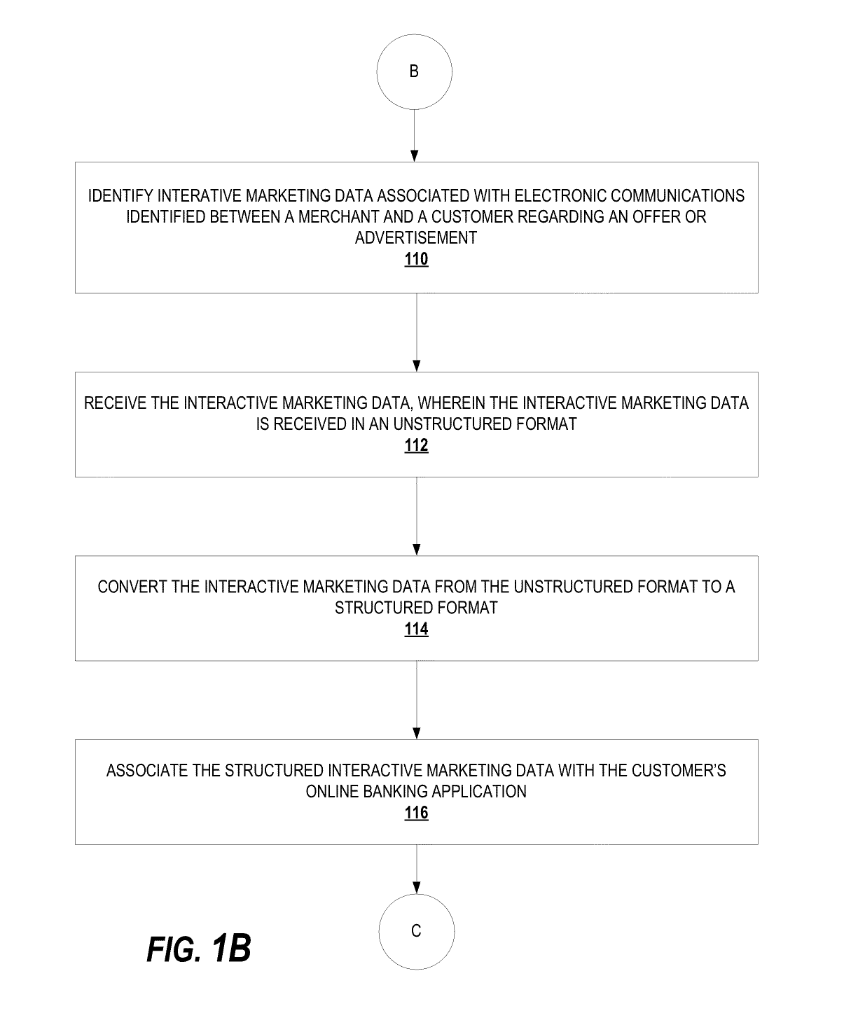

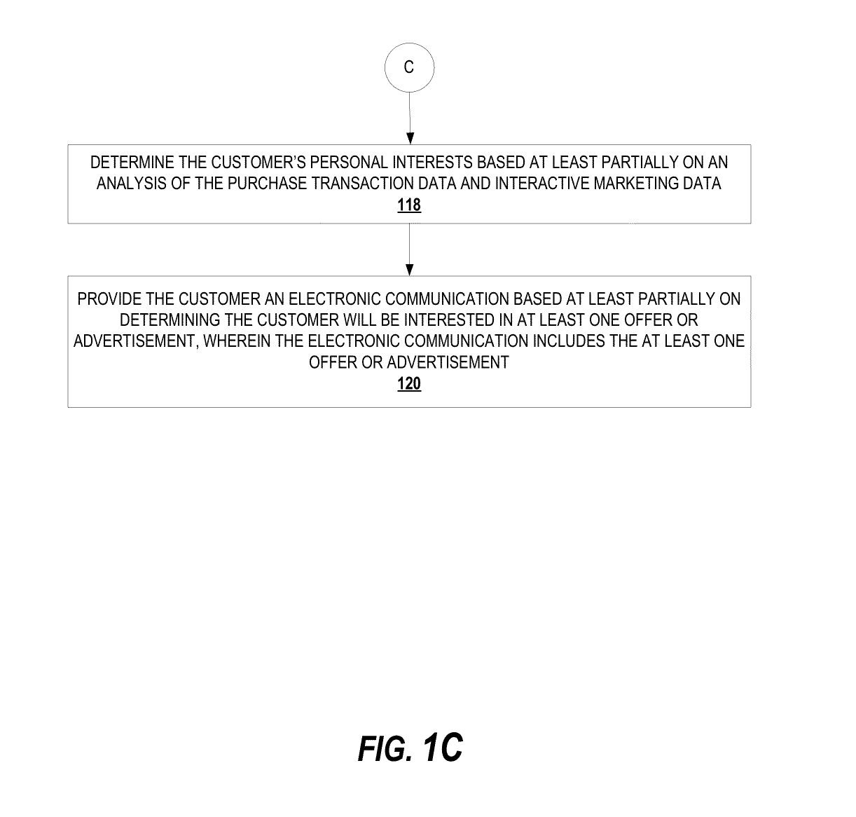

Referring now to FIG. 1A, a general process flow 100 is partially depicted for providing strategic marketing based on interactive marketing analysis. A first portion of process flow 100 is directed towards integrating product level purchase transaction data with a customer's online banking application. As such, the method may comprise one or more steps including, but not limited to, identifying purchase transaction data associated with electronic communications identified between a merchant and a customer regarding a transaction where the purchase transaction data includes product level data from a transaction 102, receiving the purchase transaction data in an unstructured format 104, converting the purchase transaction data from the unstructured format to a structured format 106, and associating the structured purchase transaction data with the customer's online banking application 108.

Referring now to FIG. 1B, the general process flow 100 is partially depicted for providing strategic marketing based on interactive marketing analysis. A second portion of the process flow 100 is directed towards integrating marketing data and promotions with a customer's online banking application. The general process flow 100 may comprise one or more additional steps including, but not limited to, identifying interactive marketing data associated with electronic communications identified between a merchant and a customer regarding an offer or an advertisement 110, receiving the interactive marketing data in an unstructured format 112, converting the interactive marketing data from the unstructured format to a structured format 114, and associating the structured interactive marketing data with the customer's online banking application 116.

Referring now to FIG. 1C, the general process flow 100 is partially depicted for providing strategic marketing based on interactive marketing analysis. A third portion of the process flow is directed towards analyzing the interactive marketing data in conjunction with the purchase transaction data to determine a user's personal interest, and like/dislikes for use in strategically marketing the user. The general process flow 100 may comprise one or more additional steps including, but not limited to determining the customer's personal interests based at least partially on an analysis of the purchase transaction data and interactive marketing data 118, and provide the customer an electronic communication based at least partially on determining the customer will be interest in at least one offer or advertisement provided within the electronic communication 120.

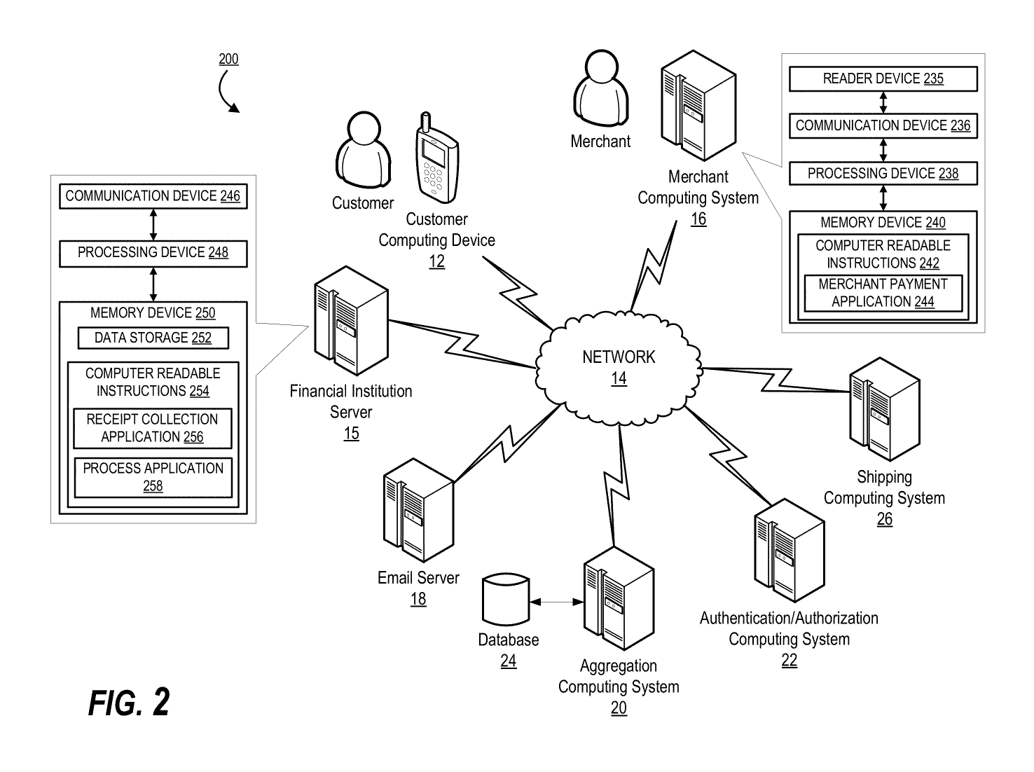

FIG. 1A provides a high level process flow illustrating the integration of purchase transaction level data from e-receipts into an online banking application process, in accordance with one embodiment of the present invention, which will be discussed in further detail throughout this specification with respect to FIG. 2 through FIG. 8. The first step in the process 100, as illustrated in block 102, is to identify purchase transaction related data associated with the communication between a merchant and a customer. Identifying purchase transaction data may additionally comprise identifying electronic communications between a merchant and a customer where the communications are regarding a transaction. In this way, the system may monitor a customer's email account, social network account, or the like to identify communications from a merchant that are associated with a recent customer transaction.

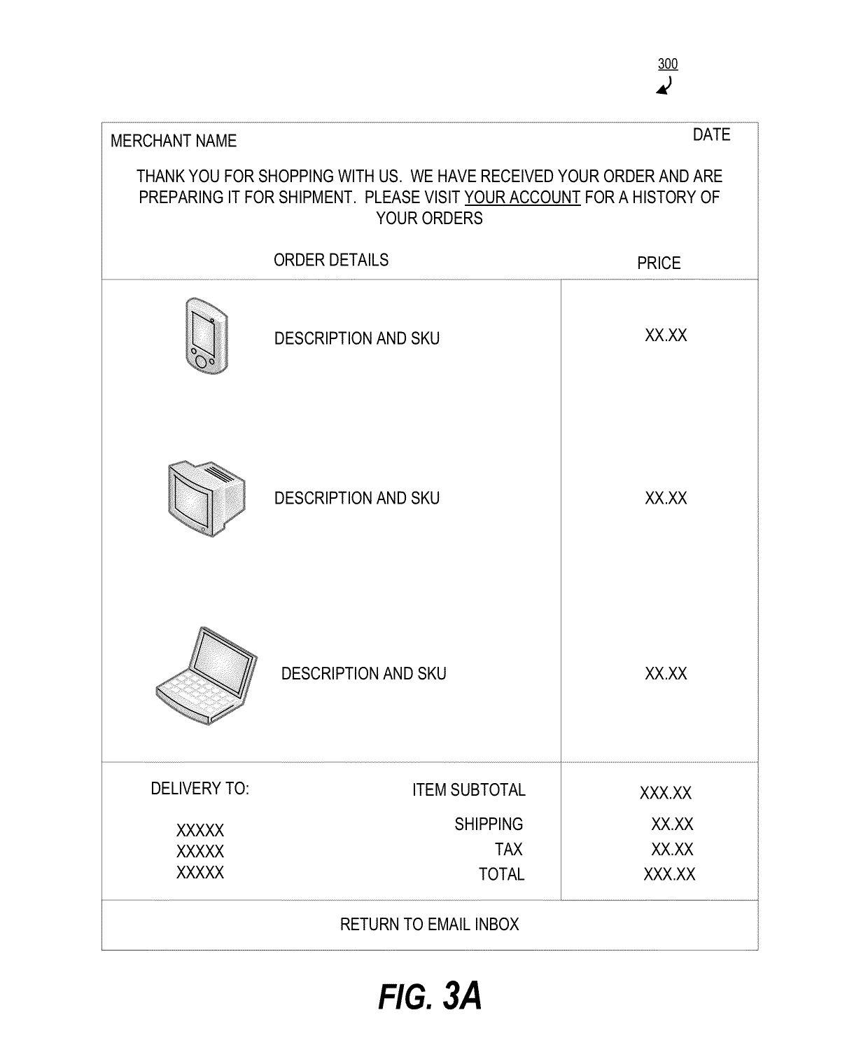

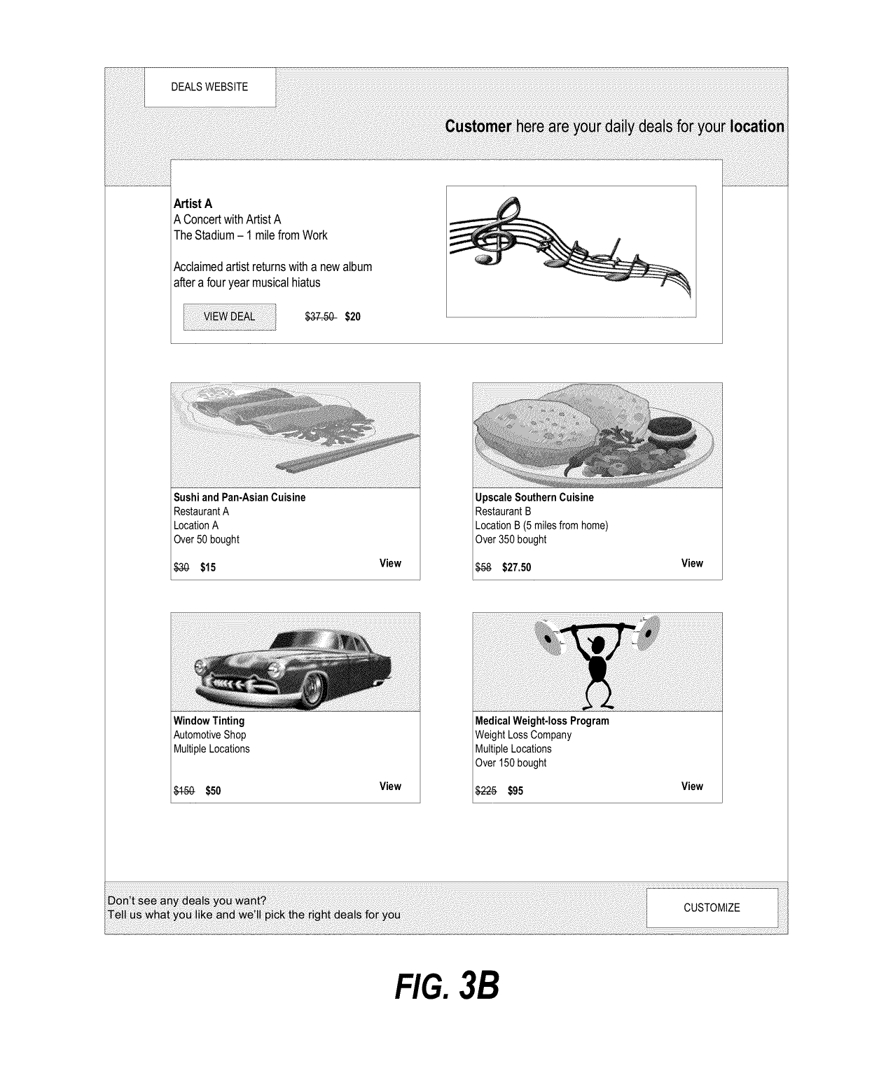

FIG. 3 illustrates an interface of an electronic communication between a merchant and a customer providing purchase transaction data to the customer 300, in accordance with one embodiment of the present invention. As illustrated in FIG. 3, one embodiment of the electronic communication may be an email from the merchant to the customer. This may be a communication outlining order details. In the example illustrated in FIG. 3, the customer purchased several items, including a cellular phone, telephone, and computer. Each of these items on the communication comprises a description of the item and the SKU number for that item. In this example, the electronic communication is an e-receipt showing the products purchased, the price of each item, the item subtotal, shipping cost, tax cost, and total cost. As such, this illustrates an example of an e-receipt for an online transaction between a customer and a merchant.

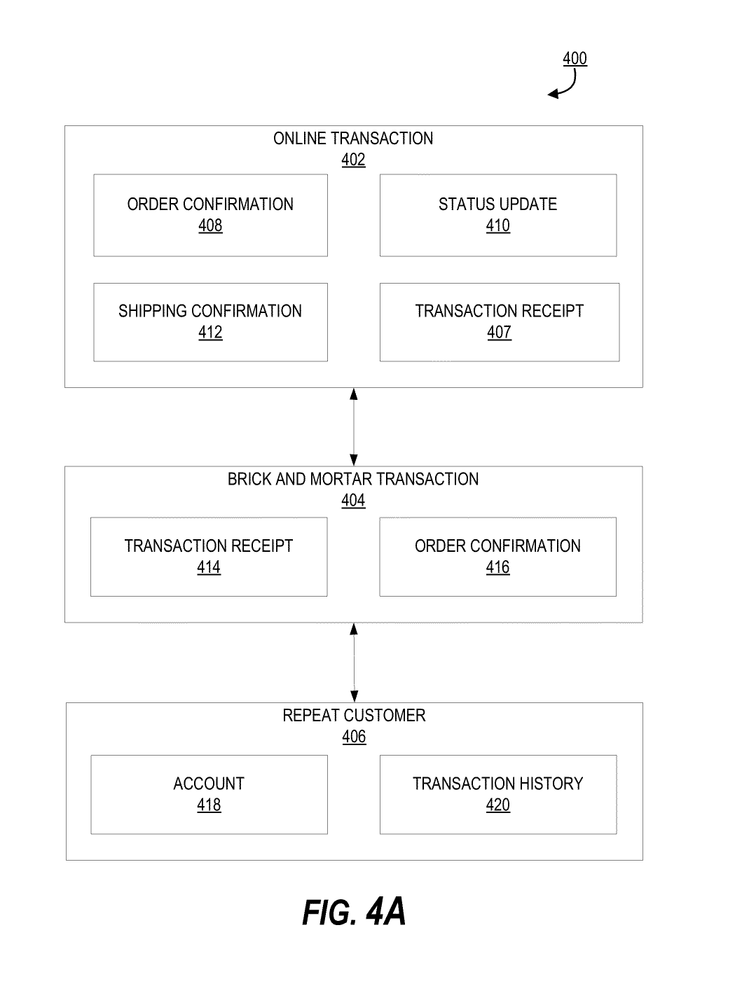

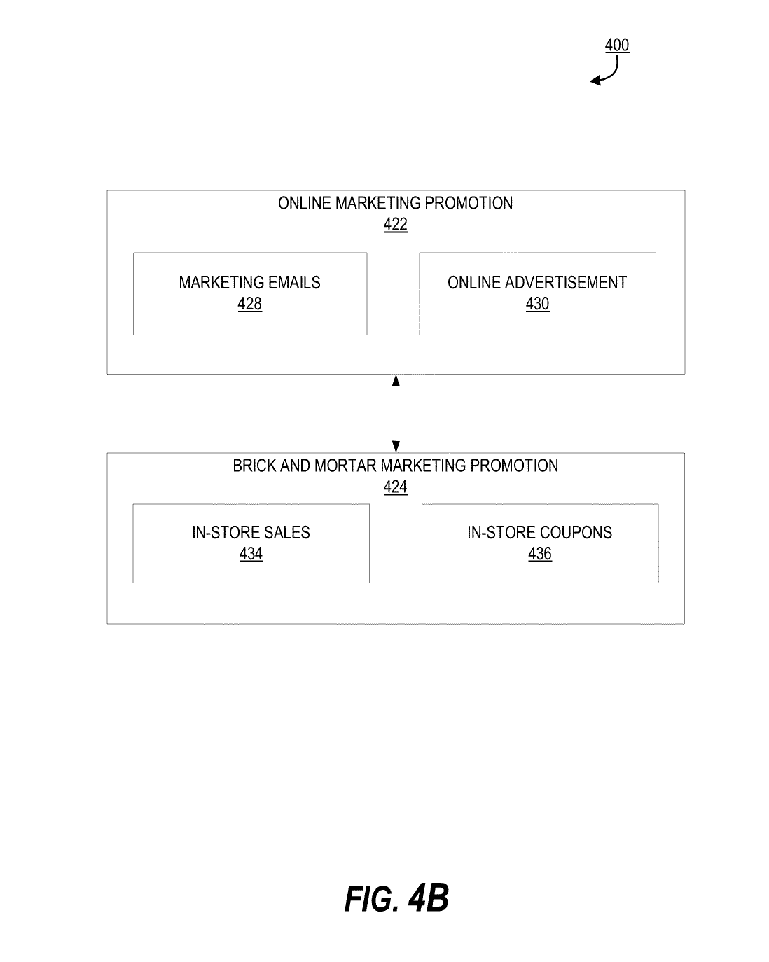

FIG. 4 illustrates a process map for the various electronic communications between a customer and merchant 400, in accordance with one embodiment of the present invention. These potential electronic communications include communications that derived from online transactions 402, brick and mortar transactions 404, or repeat customer 406 transactions.

In some embodiments, online transaction 402 communications may include transaction receipts 407. Other communications for online transactions 402 may include order confirmations 408, status updates 410, shipping updates 412, or the like. The combination of all of these communications may be considered e-receipts, as described above. E-receipts may be any electronic communication from a merchant to a customer based on a transaction. An order confirmation 408 may include detailed information regarding the products or services purchased. For example, in the case of a product, the order confirmation may include stock keeping unit “SKU” code level data, as well as other parameters, such as order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like. The order confirmation 408 also includes information about the merchant, such as name, address, phone number, web address, and the like. The shipment confirmation 412 may be an email, text, voice, or other correspondence from a merchant to a customer indicating the shipment of a product from an online transaction. Status updates 410 may include any type of communication from a merchant that may update the shipping, delivery, order, or stocking of a product of a transaction.

In some embodiments, purchase transaction communications may include communications related to transactions at a brick and mortar location 404. In this way, many merchants now also provide e-receipts and other electronic communications to customers shopping at brick and mortar locations. In some embodiments, these communications may include transaction receipts 414, such as an e-receipt. In other embodiments, these communications may include order confirmations 416. In general, at the point of sale, the customer may have previously configured or may be asked at the time of sale as to whether she wishes to receive an e-receipt. By selecting this option, the merchant will send an electronic communication in the form of an e-receipt to the customer's designated email address.

Here again, the e-receipt will typically include a list of services and/or products purchased with SKU level data, and other parameters, as well as information about the merchant, such as name, address, phone number, store number, web address, and the like.

In some embodiments, purchase transaction communications may include communications from a repeat customer account 406. Various merchants now also provide online customer accounts 418 for repeat customers. These online customer accounts 418 may include purchase history 420 information associated with the customer accessible by the customer via ID and passcode entry. Purchase history provides detailed information about services and products purchased by the customer including information found on order confirmations and shipping confirmations for each purchase. Online customer accounts are not limited to online purchases. Many merchants also provide online customer accounts for customers that purchase services and products at brick and mortar locations and then store these transactions in the customer's online account.

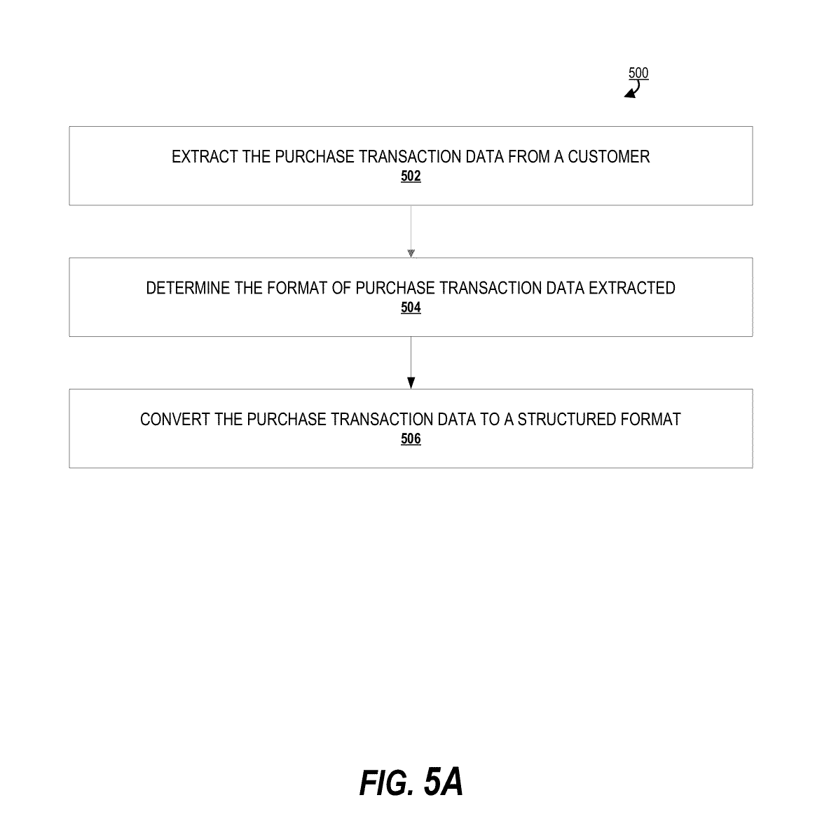

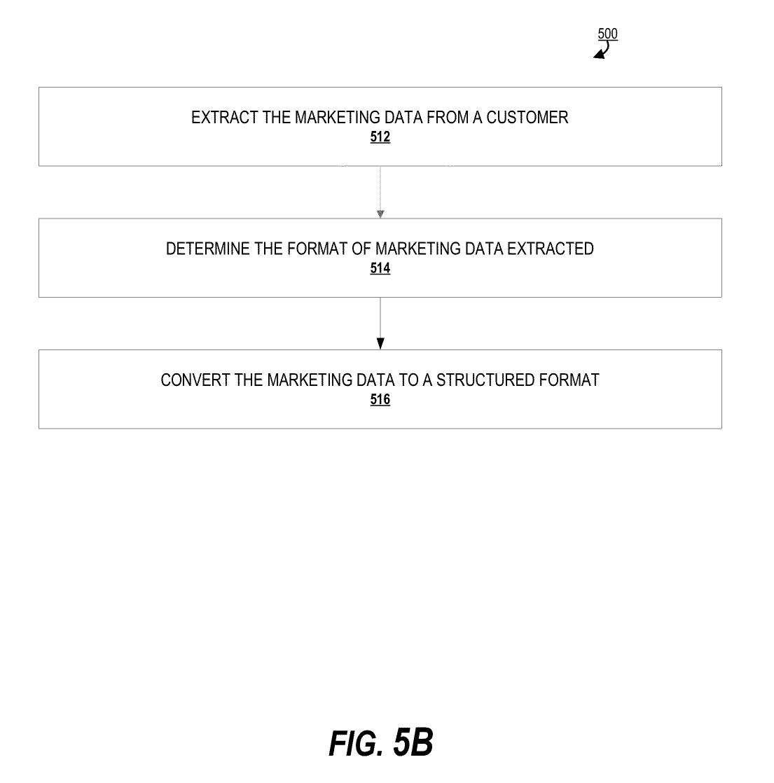

Once the purchase transaction related data is identified, the data may be converted into structured form. As such, data coming from several different servers or different merchants in an unstructured form may be processed into a structured form in block 104. FIG. 5 illustrates a process map for converting the electronic communication to usable purchase transaction level data 500, in accordance with one embodiment of the present invention. The process 500 is initiated by identifying one or more electronic communications between a customer and a merchant at step 102. The electronic communications identified are e-receipts or the like associated with a transaction between the customer and the merchant. In some embodiments, in order to identify the electronic communications the system may have access to the customer's email account or other account in which the communication is sent. In this way, the system may continue to monitor the customer's accounts in order to identify electronic communications between a merchant and customer related to a transaction. In response to identifying the one or more electronic communications, the system may identify purchase transaction data associated with the identified communication. This purchase transaction data includes product purchase level data from a transaction between the merchant and customer.

As illustrated in block 502, the system may extract the purchase transaction data identified. This extraction may be from a customer account, such as an email account or the like. In other embodiments, the extraction may be from a text, voice, or the like message communicated to the customer.

Regarding email extraction, the system may initially gains access to the customer's email accounts and retrieves email message headers comprising data fields relative to the email message, such as sender, subject, date/time sent, recipient, and the like. In some embodiments, the system accesses the emails directly. In other embodiments, the system may run search queries of the email database based on known merchant names and/or phrases associated with e-receipt information, such as “receipt,” “order confirmation,” “shipping confirmation,” or the like. Once emails are extracted, further filtering may occur to locate relevant emails. Examples of further filtering may be searches based on known online merchants, third parties known to provide e-receipts, text in the email message subject line that corresponds to known order confirmation subject line text or known shipping confirmation subject line text, such as an email message sent with a subject line containing the text “purchase,” “order,” “ordered,” “shipment,” “shipping,” “shipped,” “invoice,” “confirmed,” “confirmation,” “notification,” “receipt,” “e-receipt,” “ereceipt,” “return,” “pre-order,” “pre-ordered,” “tracking,” “on its way,” “received,” “fulfilled,” “package,” and the like.

Next, as illustrated in block 504, the process 500 continues to determine the format of the purchase transaction data extracted. As such, the unstructured format from the merchant may be identified such that it may be changed to a structured format to integrate into the online banking application. Finally, as illustrated in block 506 the system may convert the purchase transaction data to a structured format for the online banking application to utilize the purchase transaction data extracted.

Financial institutions currently use a data structure conforming to Open Financial Exchange “OFX” specifications for the electronic exchange of financial data between financial institutions, businesses and customers via the Internet. E-receipts, such as electronic order confirmations, shipment confirmation, receipts, and the like typically do not comply to a uniform structure and are generally considered to include data in an “unstructured” format. For example, while one merchant may provide data in an electronic communication to a customer in one format, another merchant may use a completely different format. One merchant may include merchant data at the top of a receipt and another merchant may include such data at the bottom of a receipt. One merchant may list the purchase price for an item on the same line as the description of the item and list the SKU number on the next line, while another merchant may list the data in a completely opposite order. As such, prior to integration of electronic communications relating to customer purchases into online banking, the data from such electronic communications must be parsed into a structured form. In some embodiments, the data is converted to a default format such as OFX. In other embodiments the data is converted to a customizable format specified by an entity such as the financial institution, merchant, third party entity, consumer, and/or a combination of the aforementioned.

Next, as illustrated in block 106, the process 100 continues by receiving the structured purchase transaction data which includes SKU level data and other product specific data, such as individual price of products, particular products, or the like.

Finally, as illustrated in block 108, the process continues by associating the purchase transaction related data into the customer's online banking application. In this way, the system may integrate the purchase transaction level data, such as the price of each product, the product type, product brand, SKU data, and the like into the customer's online banking application. Furthermore, transactions made with other payment means such as cash or credit cards associated with entities other than the financial institution providing the online banking application may also be identified. In this way, the customer's online banking may have more product specific data about a transaction. For example, a typical online banking application may identify a transaction for $XX.XX dollars at Merchant A. However, associating the purchase transaction data for that transaction may now allow an online banking application to present to the customer more data about the transaction. For example, the online banking application may now state Product 1 $X.XX, Product 2 $X.XX. Product 3 $XX.XX for a total of $XX.XX. Thus providing more detail for the products purchased during the transaction. Furthermore, the e-receipt associated with the transaction may also be presented via the customer's online banking application.

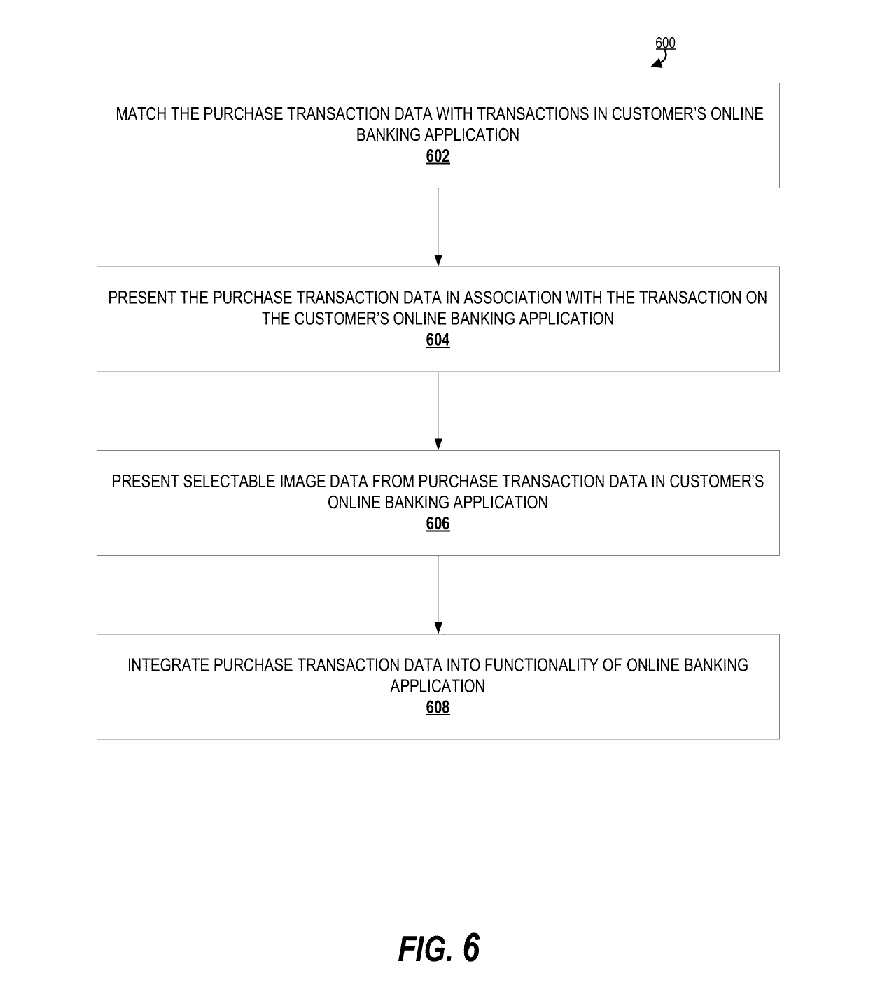

In some embodiments, associating the purchase transaction related data into the customer's online banking application may additionally comprise integrating purchase transaction data from e-receipts into an online banking application. FIG. 6 illustrates a process map for the integration of purchase transaction level data from e-receipts into an online banking application 600, in accordance with one embodiment of the present invention. The process 600 is initiated by receiving the structured purchase transaction data which includes SKU level data and other product specific data, such as individual price of products, particular products, or the like at step 104.

Next, as illustrated in block 602, the system may match the purchase transaction data with transactions in the customer's online banking application. In this way, a financial institution may have some information about a transaction which occurred utilizing one or more of the financial institution products. As such, if the customer utilized a financial institution product, the customer may visualize the purchase on his/her online banking application. Furthermore, the financial institution may identify purchase transaction data received from merchant/customer communications that match the same date, total purchase price, or merchant transaction data at the financial institution. The transaction data at the financial institution may be the total purchase price of the transaction, or other data that may be presented to a customer via an online banking application.

Once matched, the system may present the purchase transaction data in association with the transaction on the customer's online banking application, as illustrated in block 604. In this way, the system may allow a customer to see the purchase transaction level data via his/her online banking application. As such, the customer may be able to view item level spending at his/her online banking application. Thus, the customer may be able to reconcile his/her transactions and/or budget with accuracy. In this way, the system, as illustrated in block 606, may present selectable image data from the purchase transaction data in the customer's online banking application. In this way, the customer may be able to select and visualize e-receipts from his/her online banking application. As such, the customer may be able to select a transaction on his/her online banking application (where the transaction indicates the merchant and the total purchase price) and allow the customer to visualize image data from the purchase transaction. This image data may be an e-receipt or the like that illustrates the products of the transaction, SKU data, purchase price of each product of the transaction, order information, or the like.

Finally, as illustrated in block 608, the system allows for integration of the purchase transaction data into the functionality of the online banking application. In this way, the customer may be able to visualize the purchase transaction data for all transactions into his/her budgeting, expenses, or the like. As such, even cash transactions may be identified based on purchase transaction data and implemented into the functionality of the online banking application. As such, all transactions that have e-receipts or electronic communications associated with the transaction, irrespective of the payment product used by the customer, may be visualized via the customer's online banking application. In this way, not only are transaction totals for transactions utilizing the financial institution products incorporated into the online banking application, all other customer transactions (irrespective of payment product utilized) may be incorporated into the online banking application and integrated into the functionality of the online banking application.

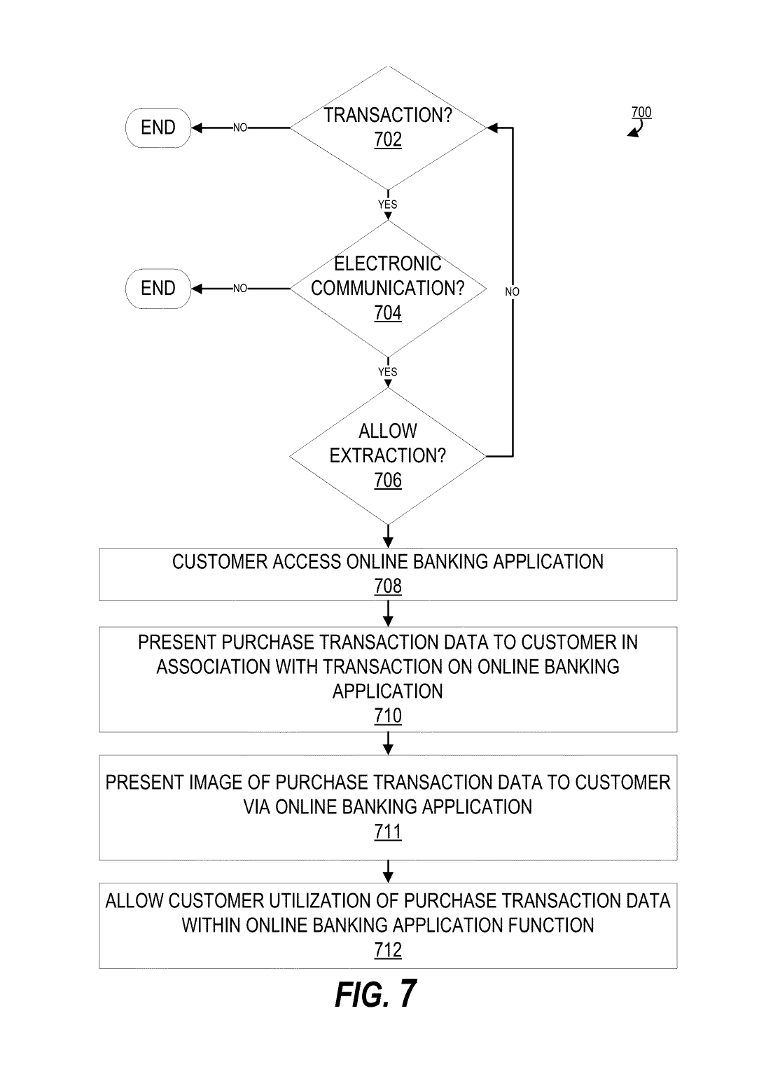

FIG. 7 illustrates a decision map for the customer's implementation of integration of purchase transaction level data from e-receipts into an online banking application process 700, in accordance with one embodiment of the present invention. As illustrated in decision block 702, the customer may enter into a transaction with a merchant. The transaction may be online or off line (at brink and mortar location). If the customer does not enter into a transaction with a merchant the process 700 is terminated. If the customer does enter into a transaction, the process 700 continues at decision block 704. At block 704 the customer may select that an electronic communication may be presented to the customer based on the transaction. In some embodiments, the electronic communication may be automatically sent to the customer if the transaction is online. In some embodiments, the electronic communication may be sent to the customer based on the customer's request, such as a purchase at a brick and mortar merchant location. In some embodiments, the electronic communication may be provided based on a customer account, such as a preferred customer account or the like, that the customer has associated with the merchant.

If there is no electronic communication in decision block 704, the process 700 is terminated. If there is an electronic communication in decision block 704, the process 700 continues to decision block 706. In decision block 706 the customer may have authorized the system to extract purchase transaction data from electronic communications. In this way, the customer may have provided the system with the account and/or passwords to access and extract electronic communications between a merchant and the customer that are in association with a customer transaction. If no extraction is allowed, then the process 700 reverts back to decision block 702, determining if a transaction has occurred between the customer and a merchant. If the customer has allowed extraction in decision block 706, the process 700 continues to block 708 where the customer may access his/her online banking application. The customer may access his/her online banking application by providing a username and a password or something similar thereto in order to access the application.

Once the customer accesses his/her online banking application the system may present purchase transaction data to the customer in association with the transaction on the online banking application, as illustrated in block 710.

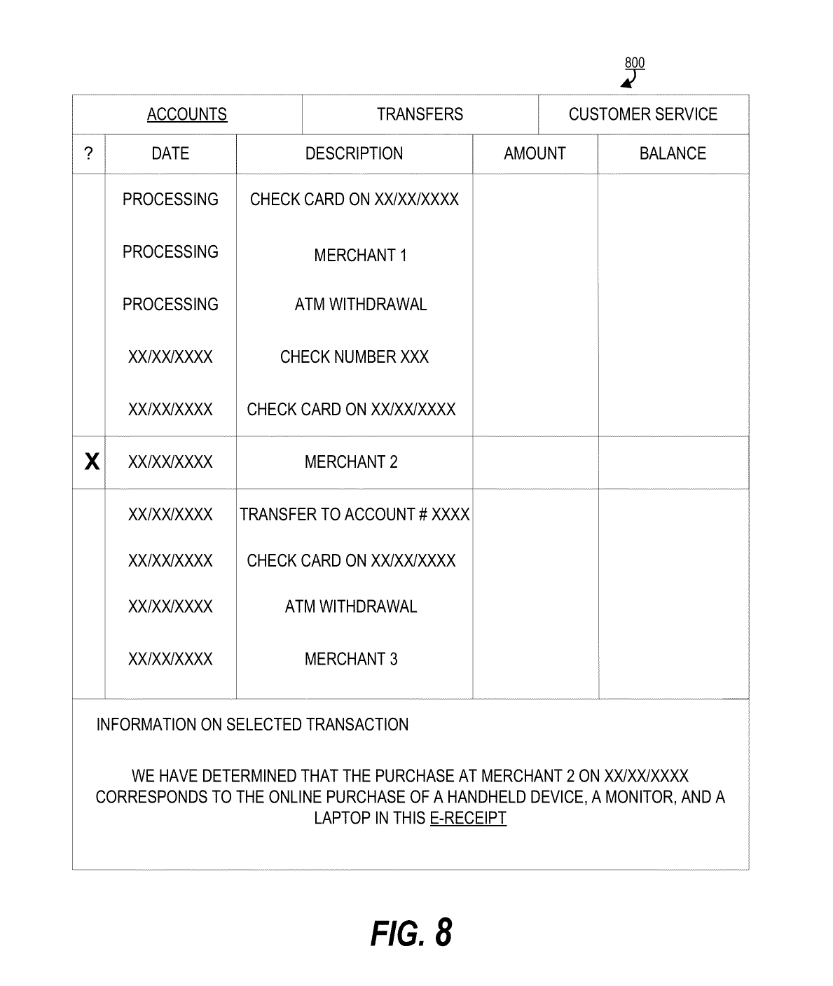

FIG. 8 provides an illustration of an interface of an online banking application with the electronic communications associated therewith 800, in accordance with one embodiment of the present invention. As illustrated in FIG. 8, the customer's online banking application shows several different transactions, including processing transactions from ATM withdrawals, check card transactions, and transactions from Merchant 1. The online banking application identifies a transaction from Merchant 2 as being one that the system has (and has matched) purchase transaction data to the transaction. In this way, the information about the transaction from Merchant 2 is presented such as that is an online purchase of a handheld device (cellular phone), monitor, and laptop. Furthermore, there is a link for the online banking application to access the e-receipt (illustrated in FIG. 3).

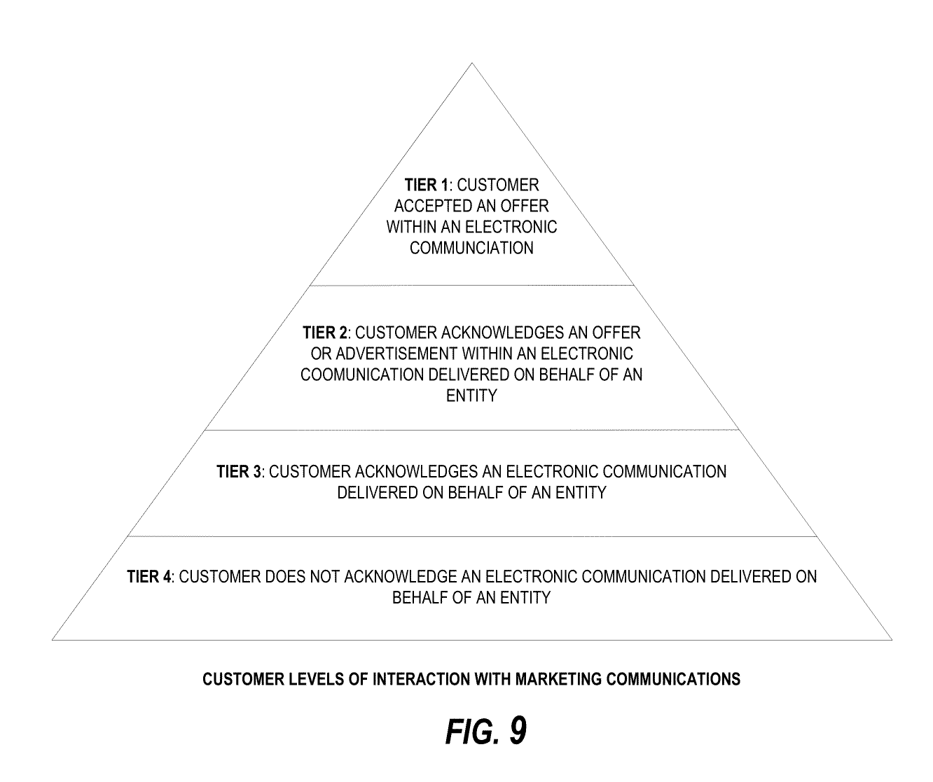

The link illustrated in FIG. 8 provides a link to the image of the purchase transaction data (such as the e-receipt illustrated in FIG. 3). Referring back to FIG. 7, the process 700 continues in block 711 by presenting the customer with an image of the purchase transaction data to the customer via the online banking application. This is further illustrated in FIG. 9. Finally, as illustrated in block 712, the system allows the customer to utilize the purchase transaction data within the online banking application functionality.

In other embodiments, associating the purchase transaction related data into the customer's online banking application may additionally comprise augmenting the features of the online banking application with the structured purchase transaction data. As such, features such as budgeting applications, or the like may be augmented with the purchase transaction level data to provide a more accurate categorization of expenses or the like.

In some embodiments, integrating the purchase transaction data may further comprise creating a personal finance management system. The process starts by receiving structured purchase transaction data including SKU level data and other product transaction level data from a customer/merchant communication. Next, the process continues to match the purchase transaction data with transactions in the customer's online banking application. In this way, the purchase transaction data from the e-receipt data as well as the information received by the online banking application. The system presents the purchase transaction data in association with the transaction on the customer's online banking application. In this way, SKU level and other product transaction level data may be provided in association with the customer's online banking application. Then, the system may build a finance management interface based on the online banking data and the purchase transaction data.

The finance management interface incorporates the online banking data and the purchase transaction data together to provide one or more of a budget application, management application, or the like. In this way, the system may build a finance management interface utilizing data from all customer transactions, even those transactions completed using cash or other financial institution derived payment devices. The financial management interface may be any type of interface that groups the financial institution online banking data with the purchase transaction data from e-receipts.

The process continues by presenting granular categorization of item level spending via the finance management interface. As such, all transactions performed by a customer whether cash, financial institution payment product, or other payment product may be identified and presented in a granular categorization based on the e-receipts extracted.

FIG. 1B provides a high level process flow illustrating the integration of interactive marketing data from electronic communications into an online banking application process, in accordance with one embodiment of the present invention. The first step in the process 100, as illustrated in block 110, is to identify interactive marketing related data associated with the communication between an entity such as a merchant and a customer. Identifying interactive marketing data may additionally comprise identifying electronic communications between a merchant and a customer where the communications are regarding a marketing promotion. In this way, the system may monitor a customer's email account, social network account, or the like to identify communications from a merchant that are associated with a marketing promotion.

FIG. 3B illustrates an interface of an electronic communication between a merchant and a customer providing marketing data to the customer 300, in accordance with one embodiment of the present invention. As illustrated in FIG. 3, one embodiment of the electronic communication may be an email from the merchant to the customer. This may be a communication outlining details of the marketing promotion. In the example illustrated in FIG. 3B, the customer is offered several deals, a primary deal pictured at the top of the email and four secondary deals. Each of these items on the communication comprises several pieces of information such as a description of the deal including the deal type, the original cost and reduced cost, and the eligible locations as well as how many people purchased the deal, and the like. In this example, the electronic communication is an marketing promotion which provides visual illustrations of several deals as well as hyperlinks to visit a secondary website and obtain more information about each of the deals. As such, this illustrates an example of an electronic communication for marketing promotion between a customer and a merchant.

FIG. 4B illustrates a process map for the various electronic communications between a customer and merchant 400, in accordance with one embodiment of the present invention. These potential electronic communications include communications that derived from online marketing promotions 422, brick and mortar marketing promotions 424, or the like.

In some embodiments, online marketing 422 communications may include marketing emails 428. Other communications for online marketing promotions 422 may include online advertisements 430, such as marketing promotions presented via social networks, web browser advertisement space or the like. The combination of all of these communications may be considered electronic marketing promotions, as described above. E-marketing promotions may be any electronic communication from a merchant to a customer based on a marketing effort. A marketing email 422 may include detailed information regarding an offer or advertisement. For example, in the case of an offer for a product, the marketing email may include an offer number, dates of the offer length, offer locations, product description, product name, maximum or minimum quantity of product eligible for offer, offer price, original product price, product image, hyperlink to the product image on a merchant website, and the like. The marketing email 428 also includes information about the merchant or entity providing the offer, such as name, address, phone number, web address, and the like.

In some embodiments, marketing communications may include communications related to marketing promotions at a brick and mortar location 424. In this way, many merchants now also provide marketing promotions such as offers and advertisements to customers shopping at brick and mortar locations. In some embodiments, these communications may include and in-store sale 434. In other embodiments, these communications may include coupons or rewards points 436. In general, at the point of sale, the customer may have previously configured or may be asked at the time of sale as to whether she wishes to receive electronic marketing promotions from the merchant. By selecting this option, the merchant may begin sending electronic communication to the customer's designated email address.

Once the interactive marketing related data is identified, the data may be converted into structured form. As such, data coming from several different servers or different merchants in an unstructured form may be processed into a structured form in block 112. FIG. 5B illustrates a process map for converting the electronic communication to usable interactive marketing level data 500, in accordance with one embodiment of the present invention. The process 500 is initiated by identifying one or more electronic communications between a customer and a merchant at step 110. The electronic communications identified are e-marketing promotion or the like associated with an offer or advertisement communicated between the customer and the merchant. In some embodiments, in order to identify the electronic communications the system may have access to the customer's email account or other account in which the communication is sent. In this way, the system may continue to monitor the customer's accounts in order to identify electronic communications between a merchant and customer related to a marketing promotion. In response to identifying the one or more electronic communications, the system may identify interactive marketing data associated with the identified communication. This interactive marketing data includes data that provides information indicating whether or not the customer acknowledged the communication and to what extent the customer interacted with the electronic communication (e.g. the customer opened the email).

As illustrated in block 512, the system may extract the interactive marketing data identified. This extraction may be from a customer account, such as an email account or the like. In other embodiments, the extraction may be from a text, voice, or the like message communicated to the customer.

Regarding email extraction, the system may initially gains access to the customer's email accounts and retrieves email message headers comprising data fields relative to the email message, such as sender, subject, date/time sent, recipient, and the like. In some embodiments, the system accesses the emails directly. In other embodiments, the system may run search queries of the email database based on known merchant names and/or phrases associated with e-marketing promotions, such as “deal,” “coupon,” “sale,” “% off,” or the like. Once emails are extracted, further filtering may occur to locate relevant emails. Examples of further filtering may be searches based on known online merchants and/or in-store merchants, third parties known to provide e-marketing, text in the email message subject line that corresponds to marketing promotions subject line text, such as an email message sent with a subject line containing the text “1 Day Only,” “2 Days Left,” “Save an Additional,” “Buy one get one free,” “weekly ad,” and the like.

Next, as illustrated in block 514, the process 500 continues to determine the format of the marketing data extracted. As such, the unstructured format from the merchant may be identified such that it may be changed to a structured format to integrate into the online banking application. Finally, as illustrated in block 516 the system may convert the marketing data to a structured format for the online banking application to utilize the marketing data extracted. Next, as illustrated in block 114, the process 100 continues by receiving the structured marketing data.

Finally, as illustrated in block 116, the process continues by associating the marketing related data into the customer's online banking application. In this way, the system may integrate the interactive marketing level data, such as an offer for a product previously purchased by the customer, and the like into the customer's online banking application.

In some embodiments, associating the marketing related data into the customer's online banking application may additionally comprise integrating interactive marketing data from electronic marketing communications into an online banking application. FIG. 6 illustrates a process map for the integration of purchase transaction level data from e-receipts into an online banking application 600, in accordance with one embodiment of the present invention. However marketing related data may be integrated into the online banking application in a similar manner. In this embodiment, the process 600 is initiated by receiving the structured interactive marketing data which includes SKU level data and other product specific data, such as individual price of products, particular products, or the like at step 104.

Next, as illustrated in block 602, the system may match the interactive marketing data with transactions in the customer's online banking application. In this way, a financial institution may have some information about a transaction which occurred utilizing one or more of the financial institution products. As such, if the customer utilized a financial institution product, the customer may visualize the purchase on his/her online banking application. Furthermore, the financial institution may identify interactive marketing data received from merchant/customer communications that match purchased product.

Once matched, the system may present the interactive marketing data in association with the transaction on the customer's online banking application, as illustrated in block 604. In this way, the system may allow a customer to see the marketing data via his/her online banking application. As such, the customer may be able to view current offer for products or similarly themed products that the customer previously purchased. The system, as illustrated in block 606, may present selectable image data from the marketing data in the customer's online banking application or a hyperlink the access more information about the offer or advertisement presented.

FIG. 1C provides a high level process flow illustrating a means for providing strategic marketing based on interactive marketing analysis, in accordance with one embodiment of the present invention. As illustrated, the process 100 may comprise one or more steps for executing a strategic marketing process. The first additional step in the process 100, as illustrated in block 118, is to determine the customer's personal interest based at least partially on an analysis of their interactive marketing data. At step 120, the system may then provide the customer with electronic communication(s) based at least partially on determining the customer's interest. To this extent, the electronic communication may include at least one offer or advertisement that has been categorized as a marketing promotion that the customer may potentially be interested in.

Determining a customer's personal interest is accomplishable in several ways. In one embodiment, illustrated by step 122, customer interests are determined based on an analysis of their interactive marketing data. In this way, the system analyzes how the customer has previously interacted with electronic communications presented and/or sent by various merchants or entities, advertisement space displayed on websites (e.g. web browsers, social networking sites, merchant websites, and the like), in-store marketing promotions, marketing promotions provided via social networking and/or third party websites, and the like.

In some embodiments, determining a customer's personal interest may comprise identifying whether or not the customer had a positive interaction with a particular electronic communication. As used herein, a positive interaction may refer to whether or not the customer exhibited interest in the content presented to them. Analyzing the customer's interactive marketing data may then comprise determining whether or not the customer acknowledged the electronic communication. A customer acknowledging a particular electronic communication may then, to some degree, indicate the customer's interest in the electronic communication.

In some embodiments, analyzing the interactive marketing data in an effort to determine the consumer's personal interest may first comprise categorizing the received data associated with various form of electronic communications. A customer's personal interest in an electronic communication or the subject matter of the electronic communication may be categorized into hierarchal tiers that indicate the level of interaction the customer had with the electronic communication. For example, the hierarchal tiers may be numbered from 1 to 4, where the higher level tiers indicate a greater interest in the electronic communication. To this extent, Tier 4 may indicate that a customer did not acknowledge the electronic communication delivered on behalf of the merchant, Tier 3 may indicate that the customer acknowledged the electronic communication delivered on behalf of the merchant (e.g. the customer opened an email), Tier 2 (secondary tier) may indicate that the customer further acknowledged an offer or advertisement contained within the electronic communication (e.g. the customer selected a hyperlink associated with an offer), and Tier 1 (primary tier) may indicate that the customer accepted one or more terms of the offer (e.g. the customer purchased a sale item advertised by the merchant within the electronic communication. In some embodiments, a customer's interest level in a particular electronic communication may be solely determined based on the level of interaction the customer had with the electronic communication; however, in other embodiments, the customer's interest in an electronic communication may be determined based on a number of factors in addition to their categorized interaction level.

In some embodiments, the electronic communication may comprise an email delivered to the customer on behalf of a particular entity, such as a merchant or a combination or merchants. In this instance, analyzing the respective interactive marketing data associated with the email may comprise determining that the customer has received the email, determining whether or not the customer opened the email, and determining whether or not the customer exhibited interest in the content of the email. As discussed herein, customer interaction associated with electronic communications are discussed in context of an email delivered to the customer; however, it should be noted that the method is also applicable to other forms of electronic communications that do not include emails.

Determining that the customer exhibited interest in the content of the electronic communication may further comprise determining that the customer opened the email and/or acknowledged the electronic communication. The system may determine that the customer has opened an email by using an email tracking software, read receipts, image request, and/or embedded personal identifiers. For example, the system may request a read receipt when sending an electronic communication to a customer. The read receipts may be either anonymous to the customer or may require the customer to explicitly specify that he or she has indeed received and/or read the content of the electronic communication. In another example, the system may use an embedded image within the content of the electronic communication to determine whether or not the user has opened the electronic communication (e.g. email). In this instance the electronic communication may comprise an image that is displayed within the content of the electronic communication but hosted on a remote server versus being directly attached to the electronic communication. When the customer opens the email, the remote server indicates that the image was downloaded by the customer and therefore the customer may be interested in the content of the electronic communication. The embedded image may be additionally associated with a personal identifier for the customer such that the remote server receives the personal identifier along with a request to download the image. In doing this, the remote server is not only informed that the image was downloaded, but also informed about who the image was downloaded by.

It should be noted, that the process related to images and embedded personal identifiers may also be used similarly with request for web addresses that are presented within the email. To this extent, the system is additionally capable of determining that the customer exhibited interest in the content of the electronic communication by determining that the customer further acknowledged an offer or advertisement presented within the electronic communication after opening it. For example, an electronic communication may present a plurality of offers or advertisements where each offer or advertisement is linked to a secondary web address such that upon selecting the link to the secondary web address the user will receive more information about the offer detailed within the electronic communication. The system may then receive a notification that provides information to indicate the customer has requested additional information for a particular offer. The customer's acknowledgement of the offer or advertisement may then be used to further determine the customer's personal interest for receiving electronic communications. In this instance, analyzing the respective interactive marketing data associated with the email may comprise determining that the customer has received the email, determining whether or not the customer opened the email, and determining whether or not the customer exhibited interest in an offer or advertisement within the email.

Determining that the customer exhibited interest in the content of the electronic communication may further comprise determining that the customer accepted an offer or advertisement presented within the electronic communication. Determining that the customer accepted an offer may comprise the merchant generating a receipt and/or receiving a payment indicating the customer purchased a product/service that was detailed in the electronic communication. Likewise, the customer may download and/or print a coupon or use a promotional code that was provided in the electronic communication. If the customer was presented with an in-store advertisement, the system may employ different method to determine whether or not the customer was interested in the advertisement. For example, if the customer was presented with an advertisement for a sale at a particular merchant site on a specific day, the system may determine that the customer accepted terms of the advertised sale if it is determined that the customer visited and or purchased products/services from the merchant on day specified in the electronic communication.

In some embodiments, the interactive marketing data is only analyzed with respect to an individual customer in determining what information to communicate to that specific customer. However, in other embodiments the system is aware of one or more demographics associated with the customer such as their age, location, occupation, financial status, and the like. The system may then determine to send the customer an electronic communication based on the average personal interest that has been determined for a demographic group to which the customer belongs. For example, if the customer is between the age of 15-25 years old, the system may determine that for that age group the average customer was acknowledged electronic communications related to video games. The system may then determine that the customer may equally be interested in receiving electronic communication related to video games.

After determining that the customer has opened and/or acknowledged an electronic communication, the system may further analyze the content of the electronic communication to determine the customer's personal interest for receiving marketing attempts. In one embodiment, the system may note the subject line and/or merchant associated with the electronic communications that the customer does not acknowledge. To this extent, the system may in part determine that the subject lines of electronic communications in which the customer acknowledged indicate the customer's personal interest to an extent and the subject lines of the electronic communications that the customer did not acknowledge indicate the customer's disinterest to an extent. The system may further determine which categories of subject lines and/or merchants are associated with the customer's interest. For example, if the customer acknowledges electronic communications related to jazz music, but ignores electronic communications related to rock and roll music, the system may determine that the customer is more interested in the music genre of jazz. This information may be subsequently used to determine an appropriate subject line for delivering electronic communications to any particular customer that will increase the probability of the customer acknowledging the electronic communication.

To this extent, providing the customer with electronic communication(s) based at least partially on determining the customer's interest, at step 118, may further comprise determining the subject line of the electronic communication to be delivered based at least partially on the customer's personal interest. Likewise, providing the customer with electronic communication(s) based at least partially on determining the customer's interest may further comprise determining the content of the electronic communications. While it may be determined that the customer generally acknowledges electronic communications that are associated with a particular subject line, the system may fill the electronic communication with offer and/or advertisement content that is related to various interest of the customer, and not particularly associated with the subject line itself. The system may determine what content the customer is interested in based at least partially on the customers previous purchases indicated in their financial history or electronic receipt data, and/or based on their personal interested determined by analyzing their interactive marketing data.

In some embodiments, providing the customer with electronic communications(s) based at least partially on their personal interest may further comprise determining to resend the customer an electronic communication that was previously sent. The system may determine that although the customer did not initially acknowledge the electronic communication based on an analysis of their current interactive marketing data the customer is interested in the content of the electronic communication. The system may be further required to update a portion of the content within the electronic communication (e.g. removing an offer, replacing an old offer with a recent promotion, and the like), if any offers have expired, prior to resending the electronic communication.

The system may be configured to first identify electronic communication(s) to provide the customer with based upon a combination of their transaction purchase history and interactive marketing data. In some embodiment, the system may identify an electronic communication associated with one or more products purchased by the customer. The electronic communication may be provided by the financial institution or an third party entity. The customer may be provided with an electronic communication based at least partially on their purchase transaction data and their interactive marketing data. For example, a financial institution may identify that the customer frequently travels and purchases airline tickets. The financial institution can then send the customer an electronic communication that comprises an offer for a credit card that is maintained by the financial institution and will double the customer's frequent flier miles if they use it to purchase their airline tickets.

The system may also identify electronic communications based on data associated with the customer's social networking accounts and/or another third party website to which the customer is associated with. For example, the customer may have an account with a third party deal website that emails the customer deals on a daily basis. The financial institution can then provide the third party website with information related to the customer's preferences for deals or marketing based on their purchase transaction data and interactive marketing data, and the third party website may only send the customers offer in which they are specifically interested in. In some embodiments, the third party website is not explicitly given the customers purchase transaction data, but are instead given information relative to the customers personal interest that have been determined by analyzing the customers purchase transaction data.

In one embodiment, the system identifies electronic communication(s) associated with a particular product name. For example, if the customer purchased songs from a media library application by Artist A or acknowledged electronic communications related to Artist A, the system may search and identify all electronic communications based on the artist name. The customer may then be provided with an electronic communication related to concert tickets for Artist A.

The system may also identify electronic communications based on one more themes and or trends associated with the customer's interactive marketing data or purchase history. For example, the system may identify a vacationing theme based on the customer purchasing, sun screen, a bathing suit, and a beach ball or the customer acknowledging electronic communications associated with vacationing. The system may then provide the customer with electronic communications related to beaches proximate to the customers region. In some embodiments, the theme is based on the customer's recent purchase transaction or interactive marketing data. In other embodiments, the theme is based on data from a specific time period, where the time period may be predetermined and specified within the user preferences. In some embodiments, the system may automatically determine user preferences for receiving offers based at least partially on the customers purchase transaction data and financial history. The data may additionally provide information that indicate previous offers that the opted into, and the system may identify the user preferences based on previous offers that the customer has opted to receive.

Customers may additionally specify the types of electronic communication(s) that they want to receive. For example, a customer may only want to receive electronic communication(s) related to a certain type of products and/or services, locations and the like. Furthermore, a customer may only be interested in receiving electronic communication(s) related to coupons and sales. In some embodiment, the customer may specify a category associated with the electronic communication(s) they wish to receive. For example, a customer may only be interested in receiving electronic communication(s) related to entertainment and/or traveling. The system may receive user preferences related to the customer's preferences for the types of electronic communication(s) they want to be provided. The system may then take the user preferences into consideration when identifying one or more electronic communication(s) such that any electronic communication not related to the user preferences are not identified by the system. Alternatively, the system may take the user preferences into consideration when providing one or more electronic communication(s) such that all for which the customer is eligible to receive are identifies but only electronic communication(s) that are related with the user preferences are communicated to the customer.

In some embodiments, customers are provided electronic communication(s) based on their eligibility for the offer and/or advertisement within the electronic communication. For example, if an electronic communication(s) is related to a debt instrument such as a credit card or loan product, the system may analyze the customer's financial history and determine whether or not the customer is eligible for the offer prior to providing the customer with the electronic communication(s). If a customer is determined to be ineligible, the system may identify one or more alternative electronic communication(s) to provide the customer with, where the customer is eligible for the alternative offers. The system may determine the customer eligibility for the alternative offer prior to providing or identifying the electronic communication(s).

Referring now to FIG. 2, FIG. 2 provides a purchase transaction level data integration system environment 200, in accordance with one embodiment of the present invention. The system environment 200 provides for retrieval of electronic communications relating to customer purchase transactions, parsing of data within such electronic communications into structured data, and inclusion of such data into online banking. As illustrated in FIG. 2, the financial institution server 15 is operatively coupled, via a network 14 to the customer computing device 12, merchant computing system 16, shipping computing system 26, authentication/authorization computing system 22, aggregation computing system 20, and the email server 18. In this way, the financial institution server 15 can send information to and receive information from the customer computing device 12, merchant computing system 16, shipping computing system 26, authentication/authorization computing system 22, aggregation computing system 20, and the email server 18. FIG. 2 illustrates only one example of an embodiment of a purchase transaction level data integration system environment 200, and it will be appreciated that in other embodiments one or more of the systems, devices, or servers may be combined into a single system, device, or server, or be made up of multiple systems, devices, or servers.

The network 14 may be a global area network (GAN), such as the Internet, a wide area network (WAN), a local area network (LAN), or any other type of network or combination of networks. The network 14 may provide for wireline, wireless, or a combination wireline and wireless communication between devices on the network 14.

In some embodiments, the customer is an individual making a transaction with a merchant. The transaction may be made at a merchant computing system 16, online or offline, over the phone, at the merchant's place of business and/or other transaction means. The purchase may be made by the customer using a customer computing device 12 such as a mobile wallet (i.e. smart phone, PDA, and the like) or other types of payment systems that communicate with the merchant computing system 16 and/or financial institution server 15 to allow the customer to enter into a transaction and/or receive communications associated with the transaction In some embodiments, the customer may be a merchant or a person, employee, agent, independent contractor, and the like acting on behalf of the merchant to enter into a transaction.

As illustrated a customer maintains one or more computing devices 12, such as a PC, laptop, mobile phone, tablet, television, or the like that is network enabled for communicating across a network 14.

Also, in the system environment 200 is one or more merchant computing systems 16 that is network enabled. In the context of an online shopping experience, the merchant computing system 16 may be one or more financial transaction servers that, either individually or working in concert, are capable of providing web pages to a customer via the network 14, receiving purchase orders for items selected by the customer, communicating with the customer and third party financial institutions to secure payment for the order, and transmitting order confirmation, and possibly shipping confirmation information, to the customer via the network 14 regarding the purchase transaction. In the context of an in-store (or brick and mortar) purchase, the merchant computing system 16 may include a point of sale terminal for scanning or receiving information about products or services being purchased by the customer and communicating with the customer and third party financial institutions to secure payment for the order. Either the point of sale device or a connected merchant server may be used to communicate order confirmation or purchase confirmation information to the customer related to the purchase transaction. If the customer has an online account with the merchant, the merchant computing system may also log the transaction information into the customer's online account.

As such, the merchant computing system 16 generally comprises a reading device 235, a communication device 236, a processing device 238, and a memory device 240. The reading device 235 is operatively coupled to the processing device 238, communication device 236, and the memory device 240. The merchant computing system 16 may include a reader device 235 to receive payment vehicle information from the customer such as online and/or offline purchases. Such a reader device 235 may include a magnetic strip reader, a barcode scanner, a radio frequency (RF) reader, a character recognition device, a magnetic ink reader, a processor for interpreting codes presented over an electrical or optical medium, a biometric reader, a wireless receiving device, and/or the like. In some embodiments, the reading device 235 receives information that may be used to identify the customer's payment vehicle and/or transaction data at the merchant computing system 16 and communicates the information via the communication device 236.

As further illustrated in FIG. 2, the merchant computing system 16 comprises computer-readable instructions 242 stored in the memory device 240, which in one embodiment includes the computer-readable instructions 242 of a merchant payment application 244.

In general, the merchant computing system 16 will provide the customer with information relating to the purchase transaction. In the context of an online purchase, the communications may take the form of purchase order confirmations provided as a web page or as an email or as both. In some, embodiments, the merchant computing system 16 may provide a web page purchase order confirmation, and advise the customer to either print, electronically save, or book mark the confirmation web page. The purchase order confirmation is essentially an e-receipt for the online purchase transaction. The order confirmation includes detailed information regarding the products or services purchased, such as for example, in the case of a product, SKU code level data, as well as other parameters associated with the product, such as type/category, size, color, and the like, as well purchase price information, information associated with the merchant, and the like. The merchant computing system 16 may also send other subsequent communications, such as communications confirming shipment of the order, which typically includes the same information as the purchase order confirmation, and in addition, shipping date, tracking number, and other relevant information regarding the order. In the context of an in-store purchase, the merchant computing system 16 may send an e-receipt comprising information similar to that of the purchase order confirmation. In some instances, the customer may actually receive a paper receipt, which the customer may choose to scan into an electronic form and save in a storage device associated with the customer computing device 12.

As such, in the embodiment illustrated in FIG. 2, the merchant payment application 244 allows the merchant computing system 16 to be linked to the financial institution server 208 and the merchant computing system 16 to communicate, via a network 201, the information related to the transaction being made such as communicating an e-receipt associated with the transaction. Furthermore, the merchant payment application 244 may be able to receive communications from the financial institution server 208 such as requests for receipts or the like.

For a plurality of different purchase transactions, a customer may include purchase transaction related data (e.g., order confirmations, shipping confirmations, e-receipts, scanned receipts, typed or handwritten notes, invoices, bills of sale, and the like) in various locations and in various forms. The purchase related data could be stored in a storage device associated with the customer computing device 12, or in an email server 18, or in a customer's account at the merchant's computing system 16. Furthermore, as mentioned, the purchase transaction related information is in an unstructured format. Each merchant may use a customized reporting format for the communications, whereby various data relating to the purchase transaction may be placed in different sequences, different locations, different formats, or the like for a given merchant. Indeed, a given merchant may even use different data formatting and structuring for different communications with the customer (e.g., order confirmation, shipping, confirmation, e-receipt, online customer account information, and the like).

To aggregate and structure data related to purchase transactions, the system environment 200 further comprises an aggregation computing system 20. The aggregation computing system is operatively connected to at least one of the customer computing device 12, the merchant computing system 16, the financial institution server 15, and the email server 18 via the network 14. The aggregation computing system 20 is configured to initially search and locate electronic communications associated with purchase transactions made by the customer, in for example, the customer's email, computer storage device, online accounts, and the like. For this purpose, the system may optionally include an authentication/authorization computing system 22 that comprises security IDs and passwords and other security information associated with the customer for accessing customer's email, storage devices, and customer online accounts.

Regarding email extraction, aggregation computing system 20 initially gains access to the customer's email accounts and retrieves email message headers comprising data fields relative to the email message, such as sender, subject, date/time sent, recipient, and the like. In some embodiments, the aggregation computing system 20 accesses the emails directly. In other embodiments, the aggregation computing system 20 may run search queries of the email database based on known merchant names and/or phrases associated with e-receipt information, such as “receipt,” “order confirmation,” “shipping confirmation,” or the like. Once emails are extracted, further filtering may occur to locate relevant emails. Examples of further filtering may be searches based on known online merchants, third parties known to provide e-receipts, text in the email message subject line that corresponds to known order confirmation subject line text or known shipping confirmation subject line text, such as an email message sent with a subject line containing the text “purchase,” “order,” “ordered,” “shipment,” “shipping,” “shipped,” “invoice,” “confirmed,” “confirmation,” “notification,” “receipt,” “e-receipt,” “ereceipt,” “return,” “pre-order,” “pre-ordered,” “tracking,” “on its way,” “received,” “fulfilled,” “package,” and the like.

In some embodiments, while extracting and aggregating user data the system is further configured to extract and aggregate data with respect to one or more rules regarding the privacy of the user. The rules may be established by the consumer, the financial institution, and or a third party entity. In some embodiments, the privacy rules are established by the consumer through an application associated with the email provider. In this way the consumer can interact with a user interface provided via the email provider and/or online banking application and set one or more restrictions and/or provisions for extracting data. The restrictions may limit access to a certain category of data or grant explicit access privileges to one or more entities.

Based on the email header analysis, the message bodies for emails of interest may then be accessed. The retrieved email message bodies for the identified email messages of interest are parsed to extract the purchase transaction information and/or shipping information contained therein. Such parsing operation can occur in a variety of known ways. However, because the text contained in email message bodies is un structured (as opposed to the structured tagged elements in a hypertext markup language (HTML) web page which delineate and make recognizable the various fields or elements of the web page), in one embodiment predefined templates are used that have been specifically created to identify the various individual elements or entities of interest in a given email from an online merchant. Use of these predefined templates to parse a retrieved email message body occurs within aggregation computing system 20. Because it is known from header information which merchant sent the email message of interest and whether the email message is a purchase order confirmation or a shipping confirmation from either the header or the message body information, a template specific to the merchant and type of confirmation may be used. Still further, because email message bodies can, as is known in the art, be in either a text or HTML format, a template specific to the type of email message body format may be used in some embodiments.

As an example, for each merchant there are typically four different parsing templates which can be used for electronic communications relating to purchase transactions: (i) a text order confirmation template; (ii) an HTML order confirmation template; (iii) a text shipping confirmation template; and (iv) an HTML shipping confirmation template. Where the email is an e-receipt from a brick and mortar purchase, another template may be used that is specific to the merchant. For some online merchants there are greater or fewer templates depending upon what are the various forms of email messages a given online merchant typically sends. Regardless of the number of templates for a given merchant, each template is specific as to the known particular entities typically included and the order they typically occur within each type of email confirmation message sent by that merchant.

The above describes parsing of email purchase order confirmation, shipping confirmation, or e-receipt data. As mentioned, a customer may scan and save paper receipts, typed or printed notes, invoices, bills of sale, and the like in a storage device or print and save purchase order and shipping confirmation communications sent to the customer by the merchant via a web page. In this instance, the aggregation computing system 20 may first perform optical character recognition “OCR” on the scanned or printed receipts prior to performing the processing performed above. Further, a customer may maintain an online account with a merchant containing purchase data information. In this instance, the aggregation computing system 20 will access the data online via communication with merchant computing system to retrieve this data. The aggregation computing system 20 may use column and/or row headers associated with the online data to parse the data, or it may use procedures similar to the above and discussed below to parse the data into appropriate fields.

Returning to data processing procedures within the system environment 200, in some embodiments, context-free grammars “CFGs” are used to parse fields from purchase transaction data. In some embodiments, instead of using grammars for parsing natural language (e.g., English) structures, the system may use defined smaller grammars describing a particular message format, for example: “(Greetings from merchant)(Details about order)(Details about item 1)(Details about item 2) . . . (Details about item N)(Tax and totals calculation),” and the like. Further, the CFGs may be individually defined, such as in a Backus-Naur Form (BNF) format, or templates may be used for data extraction. In instances, where templates are used, these created templates are grammar and can be converted by known tools, such as Another Tool for Language Recognition “ANTLR”, into mail-specific grammars or e-receipt-specific grammars or online customer account information-specific grammars. ANTLR is then used again to convert these grammars into extraction parsers, which can be used by the aggregation computing system 20 to parse the email message bodies, e-receipt bodies, online data, or the like to extract the entities of interest from them. Examples of such extracted entities include merchant name, merchant web address, order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like.

Other extraction parsers may be used, such as regular expression extraction, which can be used as a brute force pattern matching approach across the purchase information record. With this technique, each word in a given purchase order record is matched against a set of rules. If the rules are met, the piece of text matching the set of rules is returned. For example, shipping companies frequently use a 21 digit tracking number beginning with “1Z” or “91.” The aggregation computing system may scan an entire purchase information record to find a 21 digit number with “1Z” or “91” as the first 2 digits. The matched text can then be extracted and used to determine shipping information.

In another embodiment, an HTML document object model (DOM) approach may be used to parse purchase data records. For example, the message body of an email shipping notification may contain HTML code with tags for order, shipping and/or tracking information. The aggregation computing system may use these tags to identify the shipping and/or tracking information for extraction.

Once relevant information is extracted from communications between the customer and merchant regarding purchase transactions, it is stored in purchase data records in a structured database 24.

As is understood, once the purchase transaction data has been extracted, various information regarding a particular purchase transaction is now known, such as merchant name, merchant web address, order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like. This data can be further enriched with additional and/or updated information associated with products or services within the data. For example, the data may be enriched with updated shipping and delivery information from a shipping company computer system 26, product images, information about product returns, warranty information, recall information, and the like. In particular, the aggregation computing system may (1) communicate with the merchant and/or shipping company to update the shipping and delivery information extracted and stored in the database, (2) may search the merchant or the web in general to retrieve product images, and/or (3) communicate with merchant for return policies, warranties, insurance, recalls, and the like.

A portion of the above describes an aggregation computing system according to one embodiment of the present invention. An example of an aggregation computing system is described in U.S. Published Patent Application No. 2013/0024525 titled Augmented Aggregation of Emailed Product Order and Shipping Information, the contents of which are incorporated herein by reference.

As further illustrated in FIG. 2, the financial institution server 15 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 14 and other devices on the network 14, such as, but not limited to the customer computing device 12, merchant computing system 16, shipping computing system 26, authentication/authorization computing system 22, aggregation computing system 20, and the email server 18. As such, the communication device 246 generally comprises a modem, server, or other device for communicating with other devices on the network 15.

As further illustrated in FIG. 2, the financial institution server 15 comprises computer-readable instructions 254 stored in the memory device 250, which in one embodiment includes the computer-readable instructions 254 of a process application 258. In some embodiments, the computer-readable instructions 254 include a receipt collection application 256. In some embodiments, the memory device 250 includes data storage 252 for storing data related to the integration of transaction level data within online banking, including but not limited to data created and/or used by the process application 258 and/or the receipt collection application 256. In this way, the financial institution server 15 may maintain, updated, and the like the customers' online banking application.

In the embodiment illustrated in FIG. 2 the financial institution server 15 comprises a receipt collection application 256. The receipt collection application 256 allows for collection and storage of purchase transaction level data from electronic communications between a customer and merchant. This data may be sent to the financial institution server 15 by one or more other devices on the network 14, such as, but not limited to the customer computing device 12, merchant computing system 16, shipping computing system 26, authentication/authorization computing system 22, aggregation computing system 20, and the email server 18. As such, the receipt collection application 256 may receive receipt information from the other systems on the network through the communication device 246 to store the receipt, post-transaction.

In some embodiments, the receipt collection application 256 may collect receipts associated with any transaction that includes a customer. The e-receipt collection application 256 may periodically receive receipts associated with the transaction. In other embodiments, the receipt collection application 256 may also request receipts associated with customer transactions. The e-receipts may be collected from the email server 18 or the like.

In some embodiments, the system may receive the receipt from the merchant. In this way, the merchant computing system 16 may automatically send e-receipts to the financial institution server 15. As such, once a transaction has been completed between a customer 202 and a merchant associated with merchant computing system 16, the merchant computing system 16 may automatically, via the network 201, provide the receipt collection application 256 with a receipt associated with that particular transaction. In some embodiments, the system may automatically receive the receipt from the customer and/or access customer accounts to get the electronic communication data from the customer. In some embodiments, the receipt collection application 256 may automatically pull electronic communications for the customer via the email server 18. In other embodiments, the email server 18 may automatically provide the receipt collection application 256 with the electronic communications. In some embodiments, the receipt collection application 256 may receive the data from one or more of the other devices on the network 14.

In the embodiment illustrated in FIG. 2 and described throughout much of this specification, the process application 258 may integrate the purchase transaction data received from e-receipts into a customer's online banking environment.

In some embodiments, the process application 258 may integrate the purchase transaction data into the customer's online banking. In other embodiments, the process application 258 may create one or more unique finance management interfaces based on the purchase transaction data in combination with the data pre-existing on the customer's online banking application. Integration into the customer's online banking application allows for the customer to visualize at a granular level the products purchased during a transaction. For example, a typical online banking application may show a transaction using Credit Card 1 for a total of $XXX.XX from Merchant 2. There is more product level information provided to the process application 258. As such, utilizing this data for budgeting applications, reconciliation, or the like may prove to be inaccurate. As such, the process application 258 incorporates the purchase transaction data identified from an electronic communication between a customer and a merchant. Utilizing the purchase transaction data, the process application 258 may present the customer via his/her online banking application information about the transaction such as a transaction using Credit Card 1 for a total of $XXX.XX from Merchant 2 for Product 1 at MAX Product 2 at $X.XX, Product 3 at MAX Product 4 at MAX and Product 5 at $X.XX. In this way, the process application 258 may be able not only to identify each transaction and the total amount of the transaction, but instead provide product level data for each transaction. In this way, budgeting and/or reconciliation may be more accurately accomplished by the customer.

Furthermore, the process application 258 may provide a link to a copy of the e-receipt directly accessible from the online banking application. This way the customer may be able to visualize the exact communication he/she had with the merchant all while in his/her online banking application.

In some embodiments, the process application 258 may create one or more unique finance management interfaces based on the purchase transaction data in combination with the data pre-existing on the customer's online banking application. In this way the combination of purchase transaction data with the data on the customer's online banking application allow a more granular categorization of purchases based on item level spending as well as an insight into cash transaction data that prior interfaces that do not have access to that data.

It is understood that the servers, systems, and devices described herein illustrate one embodiment of the invention. It is further understood that one or more of the servers, systems, and devices can be combined in other embodiments and still function in the same or similar way as the embodiments described herein.

Any of the features described herein with respect to a particular process flow are also applicable to any other process flow. In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for providing electronic communications based on interactive marketing analysis the apparatus comprising:
a memory;
a processor; and
a module stored in the memory, executable by the processor, and configured to:
receive purchase transaction data associated with identified electronic communications between a merchant and a customer regarding a transaction, wherein the purchase transaction data includes product level data from a transaction;
receive interactive marketing data associated with identified electronic communications between a merchant and a customer regarding an offer or advertisement;
determine the customer's personal interests based at least partially on an analysis of the purchase transaction data and interactive marketing data; and
provide the customer an electronic communication based at least partially on determining the customer will be interested in at least one offer or advertisement, wherein the electronic communication includes the at least one offer or advertisement.

2. The apparatus of claim 1, wherein determining the customer's personal interest comprises the module being further configured to categorize, into hierarchical tiers, the level of interaction the customer had with the identified electronic communications.

3. The apparatus of claim 1, wherein the identified electronic communication is an email, and wherein analyzing the interactive marketing data comprises the module being further configured to:
determine the customer received the email;
determine whether or not the customer opened the email; and
determine whether or not the customer exhibited interest in the content of the email.

4. The apparatus of claim 3, wherein the module is further configured to determine the customer exhibited interest in the content of the email in response to the customer requesting additional information for the offer or advertisement provided within the electronic communication.

5. The apparatus of claim 1, wherein analyzing the interactive marketing data comprises the module being further configured to determine the customer accepted an offer presented in the identified electronic communication in response to the merchant receiving a payment from the customer for a product or service provided in the offer.

6. The apparatus of claim 1, wherein analyzing the interactive marketing data comprises the module being further configured to determine the customer was interested in an advertisement presented in the identified electronic communication in response to determining the customer purchased a product or service from a merchant on a day specified in the advertisement.

7. The apparatus of claim 1, wherein analyzing the interactive marketing data comprises the module being further configured to determine the customer was interested in an offer presented in the identified electronic communication in response to the customer downloading a coupon or using a promotional code provided in the electronic communication.

8. The apparatus of claim 1, wherein providing the customer an electronic communication comprises the module being further configured to:
determine, based on the customer's personal interest, a subject line for the electronic communication such that the subject line will increase the probability of the customer acknowledging the electronic communication; and
determine, based on the customer's personal interest, the content of the electronic communication such that the customer will be interested in at least one offer or advertisement provided in the electronic communication.

9. The apparatus of claim 1, wherein providing the customer an electronic communication comprises the module being further configured to:
determine to resend the customer an electronic communication that was previously sent; and
update a portion of the content within the electronic communication, if any offers have expired, prior to resending the electronic communication.

10. The apparatus of claim 1, wherein the purchase transaction data is received in an unstructured format, and wherein the module is further configured to:
convert the purchase transaction data from the unstructured format to a structured format; and
associate the structured purchase transaction data with the customer's online banking application.

11. The apparatus of claim 1, wherein the interactive marketing data is received in an unstructured format, and wherein the module is further configured to:
convert the interactive marketing data from the unstructured format to a structured format; and
associate the structured interactive marketing data with the customer's online banking application.

12. A method for providing electronic communications based on interactive marketing analysis, the method comprising:
receiving, using a computer processing device, purchase transaction data associated with identified electronic communications between a merchant and a customer regarding a transaction, wherein the purchase transaction data includes product level data from a transaction;
receiving, using a computer processing device, interactive marketing data associated with identified electronic communications between a merchant and a customer regarding an offer or advertisement;
determining, using a computer processing device, the customer's personal interests based at least partially on an analysis of the purchase transaction data and interactive marketing data; and
providing, using a computer processing device, the customer an electronic communication based at least partially on determining the customer will be interested in at least one offer or advertisement, wherein the electronic communication includes the at least one offer or advertisement.

13. The method of claim 12, wherein determining the customer's personal interest comprises categorizing, into hierarchical tiers, the level of interaction the customer had with the identified electronic communications.

14. The method of claim 12, wherein the identified electronic communication is an email, and wherein analyzing the interactive marketing data comprises:
determining the customer received the email;
determining whether or not the customer opened the email; and
determining whether or not the customer exhibited interest in the content of the email.

15. The method of claim 12, wherein providing the customer an electronic communication comprises:
determining, based on the customer's personal interest, a subject line for the electronic communication such that the subject line will increase the probability of the customer acknowledging the electronic communication; and
determining, based on the customer's personal interest, the content of the electronic communication such that the customer will be interested in at least one offer or advertisement provided in the electronic communication.

16. The method of claim 12, wherein providing the customer an electronic communication comprises:
determining to resend the customer an electronic communication that was previously sent; and
updating a portion of the content within the electronic communication, if any offers have expired, prior to resending the electronic communication.

17. The method of claim 12, wherein the purchase transaction data and interactive marketing data are received in an unstructured format, and wherein the method further comprises:
converting the purchase transaction data from the unstructured format to a structured format;
associating the structured purchase transaction data with the customer's online banking application;
converting the interactive marketing data from the unstructured format to a structured format; and
associating the structured interactive marketing data with the customer's online banking application.

18. A computer program product for providing electronic communications based on interactive marketing analysis, the computer program product comprising:
a non-transitory computer-readable medium comprising a set of codes for causing a computer to:
receive purchase transaction data associated with identified electronic communications between a merchant and a customer regarding a transaction, wherein the purchase transaction data includes product level data from a transaction;
receive interactive marketing data associated with identified electronic communications between a merchant and a customer regarding an offer or advertisement;
determine the customer's personal interests based at least partially on an analysis of the purchase transaction data and interactive marketing data; and
provide the customer an electronic communication based at least partially on determining the customer will be interested in at least one offer or advertisement, wherein the electronic communication includes the at least one offer or advertisement.

19. The computer program product of claim 18, the computer program product further comprising a set of codes for causing a computer to categorize, into hierarchical tiers, the level of interaction the customer had with the identified electronic communications.

20. The computer program product of claim 18, wherein the identified electronic communication is an email, and wherein the computer program product further comprising a set of codes for causing a computer to:
determine the customer received the email;
determine whether or not the customer opened the email; and
determine whether or not the customer exhibited interest in the content of the email.

21. The computer program product of claim 18, the computer program product further comprising a set of codes for causing a computer to
determine, based on the customer's personal interest, a subject line for the electronic communication such that the subject line will increase the probability of the customer acknowledging the electronic communication; and
determine, based on the customer's personal interest, the content of the electronic communication such that the customer will be interested in at least one offer or advertisement provided in the electronic communication.

22. The computer program product of claim 18, the computer program product further comprising a set of codes for causing a computer to:
determine to resend the customer an electronic communication that was previously sent; and
update a portion of the content within the electronic communication, if any offers have expired, prior to resending the electronic communication.

23. The computer program product of claim 18, wherein the purchase transaction data and interactive marketing data are received in an unstructured format, and wherein the computer program product further comprising a set of codes for causing a computer to:
convert the purchase transaction data from the unstructured format to a structured format;
associate the structured purchase transaction data with the customer's online banking application;
convert the interactive marketing data from the unstructured format to a structured format; and
associate the structured interactive marketing data with the customer's online banking application.
